(19) United States
(12) Patent Application Publication
(10) Pub. No.: US 2015/0363762 A1
(43) Pub. Date: Dec. 17, 2015

(54) APPARATUS, METHOD, AND COMPUTER PROGRAM PRODUCT FOR MOBILE OPEN PAYMENT NETWORK

(71) Applicant: MasterCard International Incorporated, Purchase, NY (US)

(72) Inventor: Deborah M. Kimberg, Chesterfield, MO (US)

(21) Appl. No.: 14/731,566

(22) Filed: Jun. 5, 2015

Related U.S. Application Data
(60) Provisional application No. 62/012,340, filed on Jun. 14, 2014.

(51) Int. Cl. G06Q 20/32; G06Q 20/10

(52) U.S. Cl. CPC G06Q 20/322; G06Q 20/102

(57) ABSTRACT

An electronic system for mobile open payments obtains, from a first mobile telephony provider entity, first merchant registration information; and assigns a unique merchant identifier to identify the first merchant. The system obtains, from a second mobile telephony provider entity, a query, initiated based on a payment instruction from a customer of the first merchant and the second mobile telephony provider entity instructing the first merchant to be paid a certain amount. The query includes the unique merchant identifier of the first merchant. The system looks up in a database, via a query on the unique merchant identifier, at least a portion of the first merchant registration information; and provides, to the second mobile telephony provider entity, at least the portion of the first merchant registration information. This facilitates real-time payment to the merchant, who receives a notification of payment and releases goods or services.

### CROSS-REFERENCE TO RELATED APPLICATIONS

This patent application claims the benefit of U.S. Provisional Patent Application Ser. No. 62/012,340 filed on 14 Jun. 2014 and entitled “APPARATUS, METHOD, AND COMPUTER PROGRAM PRODUCT FOR MOBILE OPEN PAYMENT NETWORK.” The complete disclosure of the aforementioned U.S.

Provisional Patent Application Ser. No. 62/012,340 including all appendices thereof is expressly incorporated herein by reference in its entirety for all purposes.

### FIELD OF THE INVENTION

The present invention relates generally to the electronic and computer arts, and, more particularly, to electronic payment techniques implemented via mobile telephony and the like.

### BACKGROUND OF THE INVENTION

The use of payment cards, such as credit cards, debit cards, and pre-paid cards, has become ubiquitous. Most payment card accounts have one or more associated physical cards; however, the use of non-traditional payment devices, such as appropriately configured “smart” cellular telephones, is increasing.

The process of electronic bill presentment and payment has also been popular for quite some time. For example, U.S. Pat. No. 5,699,528 to Hogan (expressly incorporated herein by reference in its entirety for all purposes) discloses a system and method for bill delivery and payment over a communications network. In the bill delivery and payment system, users are able to access a server computer on a communications network to obtain bill information and pay bills.

US Patent Publication 2014-0067620 of Blinov (expressly incorporated herein by reference in its entirety for all purposes) discloses techniques for purchasing by crediting a merchant's card, in connection with an on-line purchase of goods.

### SUMMARY OF THE INVENTION

Principles of the present invention provide techniques for a mobile open payment network. In one aspect, an exemplary method includes the steps of: obtaining, at an electronic system for mobile open payments, from a first mobile telephony provider entity, first merchant registration information including at least a merchant name and address of a first merchant who is a customer of the first mobile telephony provider entity and who is registering with the first mobile telephony provider entity to receive mobile payments; assigning, from the electronic system for mobile open payments, to the first mobile telephony provider entity, a unique merchant identifier to identify the first merchant; and obtaining, at the electronic system for mobile open payments, from a second mobile telephony provider entity, a query, initiated based on a payment instruction from a customer of the first merchant and the second mobile telephony provider entity instructing the first merchant to be paid a certain amount. The query includes the unique merchant identifier of the first merchant. Further steps include looking up, in a database, by the electronic system for mobile open payments, via a query on the unique merchant identifier of the first merchant, at least a portion of the first merchant registration information; and providing, from the electronic system for mobile open payments, to the second mobile telephony provider entity, at least the portion of the first merchant registration information.

In another aspect, another exemplary method includes the steps of: obtaining, by a first mobile telephony provider entity, first merchant registration information including at least a merchant name and address of a first merchant who is a customer of the first mobile telephony provider entity and who is registering with the first mobile telephony provider entity to receive mobile payments; providing, by the first mobile telephony provider entity, to an electronic system for mobile open payments, the first merchant registration information; obtaining, from the electronic system for mobile open payments, by the first mobile telephony provider entity, a unique merchant identifier to identify the first merchant; and providing, by the first mobile telephony provider entity, to the first merchant, the unique merchant identifier, for display by the first merchant to solicit the mobile payments.

In still another aspect, still another exemplary method includes the steps of: obtaining, at a customer's mobile telephony provider entity, from a customer who is a customer of the mobile telephony provider entity and a merchant, a first mobile telephony message including a unique merchant identifier and an amount due, in connection with a transaction between the customer and the merchant wherein the unique merchant identifier is displayed to the customer; charging, by the customer's mobile telephony provider entity, to an account of the customer, funds to pay the amount due; and causing, by the customer's mobile telephony provider entity, a request for a special payment transaction wherein funds will be deposited to a payment card account of the merchant, to be dispatched into a payment card network.

Aspects of the invention contemplate the method(s) described herein performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the invention can provide substantial beneficial technical effects, as will be appreciated by the skilled artisan from the discussion herein. For example, one or more embodiments allow mobile-to-mobile purchases of goods and services using any consumer's mobile device as a terminal to purchase goods and/or services by initiating payment, and the receiver's mobile device as a proxy for the receive account. In one or more embodiments, payments and notifications occur in real-time to the merchant, providing the merchant confirmation the payment is made and the good or service can be released to the buyer. Use of mobile telephony-centric payment techniques, as disclosed herein, is technologically advantageous in providing greater security in developing regions with limited payment processing infrastructure, as compared to current techniques. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement at least a portion of some techniques of the invention;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, useful in connection with one or more embodiments of the invention;

FIG. 3 shows exemplary operation of a bill pay system, in accordance with an aspect of the invention;

FIG. 4 shows exemplary operation of current automated clearinghouse payments;

FIG. 5 is a block diagram of a “smart” phone or tablet computer useful in one or more embodiments of the invention;

FIG. 6 is a system block diagram of an exemplary system, in accordance with an aspect of the invention;

FIG. 7 is a block diagram of an exemplary computer system useful in one or more embodiments of the invention;

FIG. 8 is an exemplary software architecture diagram, in accordance with an aspect of the invention;

FIGS. 9 and 10 provide an exemplary detailed view of operation of an exemplary payment card network, in accordance with an aspect of the disclosure;

FIG. 11 shows a group of payment network interface processors, such as may be used with the network of FIGS. 9 and 10;

FIG. 12 shows a port arrangement on a payment network interface processor, such as may be used with the network of FIGS. 9 and 10; and

FIG. 13 shows an illustrative case wherein an issuer has multiple payment network interface processors.

### DETAILED DESCRIPTION OF PREFERRED EMBODIMENTS

### Payment Devices and Associated Payment Processing Networks

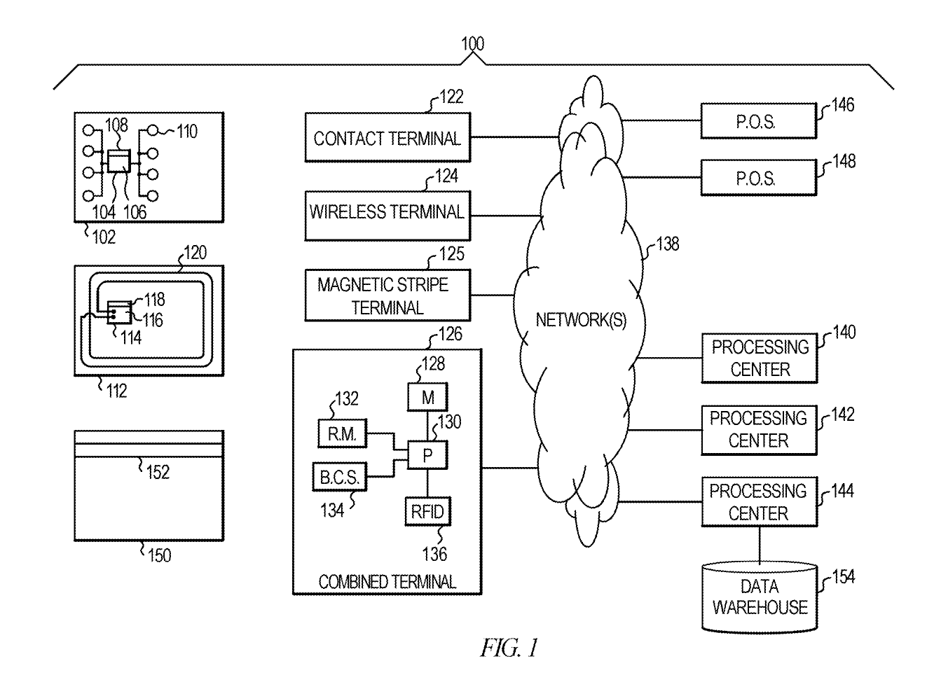

With regard to payment card and similar payments, attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 typically functions with other types of devices in lieu of or in addition to “smart” or “chip” cards 102, 112; for example, a conventional card 150 having a magnetic stripe 152. Furthermore, an appropriately configured mobile device (e.g., “smart” cellular telephone handset, tablet, personal digital assistant (PDA), and the like) can be used to carry out contactless payments in some instances; for example, via near field communications (NFC), wherein the appropriately configured mobile device acts like a contactless card 112 (or, with an electronic wallet present, like multiple such cards). It is worth noting that in one or more embodiments of the invention, a mobile device such as a mobile phone is used to initiate a payment to a merchant without the need for the mobile device to use NFC to act like a contactless card, and without the need for the merchant to have a terminal 122, 124, 125, 126.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present invention is the MULTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, N.Y., USA (marks of MasterCard International Incorporated of Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

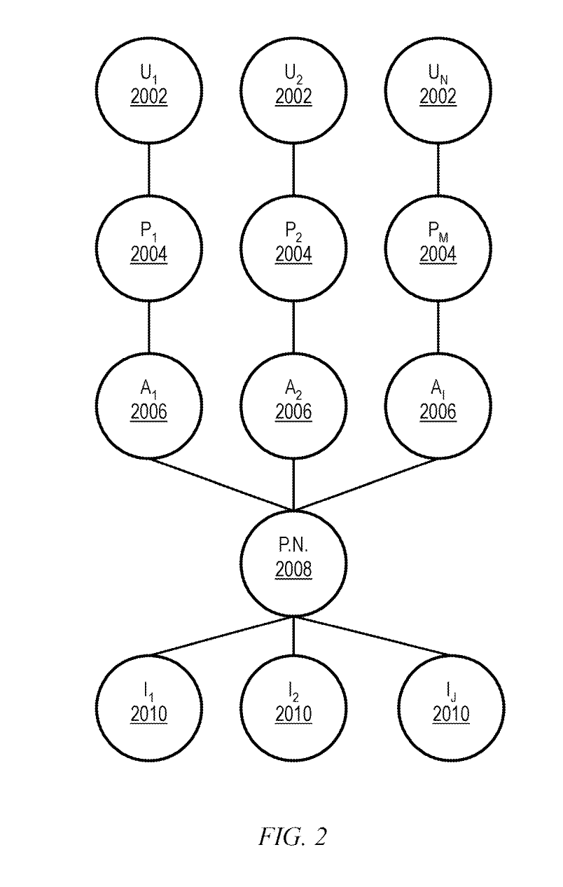

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Again, in one or more embodiments small merchants do not need to have a terminal 122, 124, 125 or 126.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone, tablet, or the like.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 150. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be International Organization for Standardization (ISO) 7816-compliant contact cards or devices or NFC (Near Field Communications) or ISO 14443-compliant proximity cards or devices. In operation, card 112 can be touched or tapped on the terminal 124 or 128 (or an associated reader), which then contactlessly transmits the electronic data to the proximity IC chip in the card 112 or other wireless device.

One or more of the processing centers 140, 142, 144 can include a database such as a data warehouse 154.

It should be noted that while one or more embodiments are directed to mobile transactions at brick and mortar locations, the system depicted in FIG. 1 may in general involve not only conventional transactions at “brick and mortar” merchants, but also card-not-present transactions, such as card-not-present Internet transactions or card-not-present recurring payments. In some instances, an Internet Protocol (IP) address may be captured during card-not-present Internet transactions. In exemplary card-not-present Internet transactions, an individual utilizes his or her home computer to communicate with a server of an e-commerce merchant over the Internet. The individual provides his or her PAN to the merchant's server. The merchant utilizes the PAN to initiate an authorization request, and upon receiving an authorization request response indicating approval, will complete the e-commerce transaction. In exemplary card-not-present recurring payments, an individual provides his or her PAN and related data to a merchant (e.g., via phone or postal mail). The merchant utilizes the PAN to initiate an authorization request, and upon receiving an authorization request response indicating approval, will complete the recurring transaction.

In some cases, there can be payment card accounts which do not have physical cards or other physical payment devices associated therewith; for example, a customer can be provided with a PAN, expiration date, and security code but no physical payment device, and use same, for example, for card-not-present telephone or internet transactions. In this regard, a “cardholder” should be understood to refer to the account holder of a payment card account, regardless of whether the holder actually has a physical payment card or other physical payment device.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal. Note, also, that elements 2006, 2010 represent the entities that actually carry out processing for the acquirers and issuers respectively; in some instances, these entities carry out their own processing; in other entities, they utilize acquirer processors and issuer processors, respectively.

During a conventional credit authorization process, the cardholder 2002 pays for the purchase and the merchant 2004 submits the transaction to the acquirer (acquiring bank) 2006. The acquirer verifies the card number, the transaction type, and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

It will be appreciated that the network 2008 shown in FIG. 2 is an example of a payment network configured to facilitate transactions between multiple issuers and multiple acquirers, which may be thought of as an “open” system. Some embodiments of the invention may be employed in relation to payment card accounts using other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer are the same entity.

Messages within a network such as network 138 and/or network 2008, may, in at least some instances, conform to the International Organization for Standardization (ISO) Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of, payment card transactions for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing or procurement card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN)(which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. No. 6,636,833 (expressly incorporated herein by reference in its entirety for all purposes) and U.S. Pat. No. 7,136,835 (expressly incorporated herein by reference in its entirety for all purposes) of Flitcroft et al.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network. Other non-limiting examples of payment card networks include the AMERICAN EXPRESS® and DISCOVER® networks.

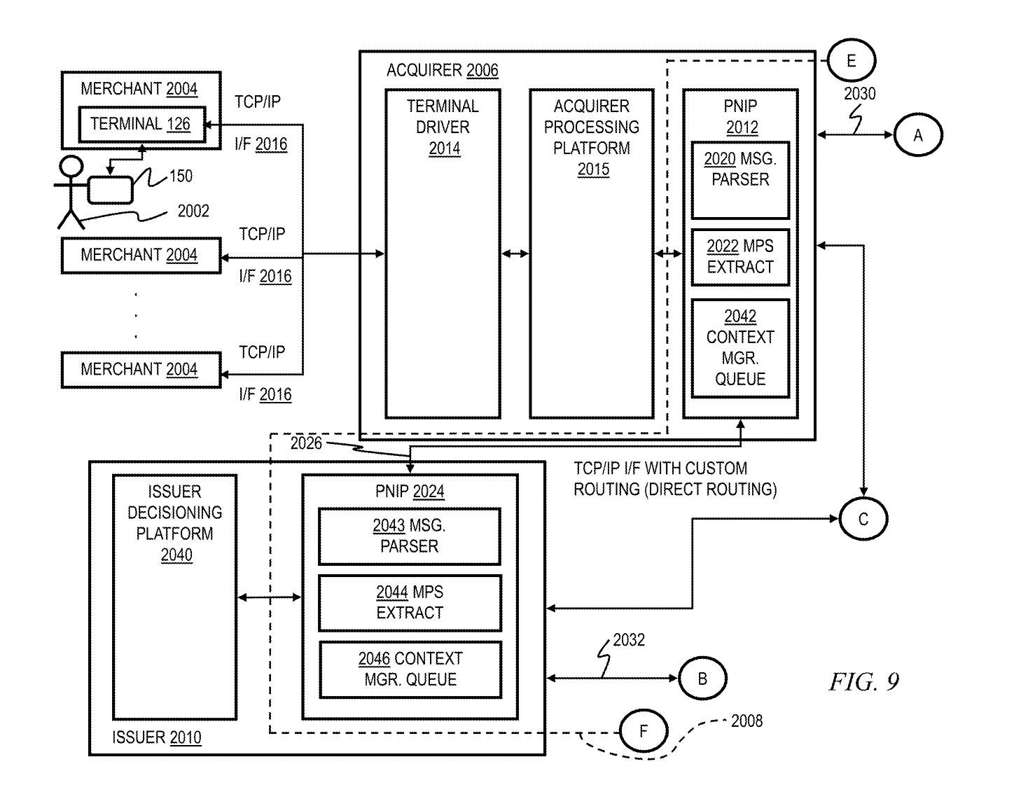

Still referring to FIG. 2, and with reference also now to FIGS. 9 and 10, by way of review and provision of additional detail, a consumer 2002 effectively presents his or her card 150 or other payment device (e.g., presents suitably configured “smart” phone or uses an e-wallet) to the terminal 126 of a merchant 2004. A mag stripe card 150 and combined terminal 126 are shown by way of example, but are intended to generally represent any kind of payment device and any kind of terminal. The effective presentation can happen directly (user enters a brick and mortar location of a merchant 2004) or virtually (user logs on to a web site of a merchant 2004 via a browser of a personal computer or the like, or calls on the telephone, and provides card information, or sends a “snail” mail with payment card account information to a hospital or other inpatient treatment facility). The merchant terminal 126 captures the card account information (by swiping or wireless communication if directly presented; by manual keying or reading data if remote) and forwards same to the acquirer 2006. Interaction between the merchant and cardholder is outside the purview of the payment card network per se. The payment card network becomes involved at the connection between the acquirer 2006 and network 2008; the dotted line between points E and F in FIGS. 9 and 10 encompasses the network 2008. Note generally that points A, B, C, E, and F in FIG. 9 connect to the corresponding points in FIG. 10; the entire network and associated environment are not amenable to illustration on a single sheet.

Again, note that initially, conventional operation of a payment card network is being described; one or more embodiments do not require the presentation of a card 150 to a terminal 126 but utilize aspects of network 2008 to make payments as described elsewhere herein.

The acquirer 2006, in the specific example of FIGS. 9 and 10, has at its premises a payment network interface processor (PNIP 2012). The MasterCard Interface Processor or MIP is a non-limiting example of a PNIP. In a non-limiting example, the PNIP is implemented on a rack-mounted server. PNIPs are typically located at the edges of the payment card network. In at least some instances, the payment card network of FIG. 2 is a distributed network wherein each acquirer and issuer has at least one PNIP on their premises. Each acquirer 2006 will have a relationship with one or more merchants 2004 and will interface with the merchants' terminals 126 via terminal driver 2014 (an acquirer may also act as an acquirer for themselves as a merchant). Furthermore in this regard, the merchant locations will have terminals where the cards are swiped (or where contacted or contactless devices are presented). The acquirer will employ terminal driver 2014 to interface with those terminals. Terminal driver 2014 is a logical block representing software and/or hardware that allows the acquirer processing platform 2015 to communicate with the terminals of the merchants via TCP, dial up, or the like (TCP/IP interfaces 2016 are shown in the example in the figures). Each merchant will decide what acquirer to use to accept one or more brands of payment cards, and the acquirer will set the merchant up with the appropriate software and/or firmware for the merchant's point of sale devices.

The acquirer 2006 will present transactions from many different merchants 2004 to the payment card network operator 2008 via the PNIP interface 2012. The connection between the merchants 2004 and the acquirer 2006 is typically a TCP/IP interface 2016. The format that the transaction is in when the card is swiped at the merchant 2004 may differ from the format that the transaction is in when actually received by the payment card network operator. The acquirer may convert the transaction into the ISO 8583 format or into a format that is a specific implementation of the ISO 8583 format (e.g., the MASTERCARD CIS (customer interface specification) format. The authorization request message can be an ISO 8583 message type identifier (MTI) 0100 message, for example, sent over the communications interface 2016 between the merchant 2004 and the acquirer 2006.

Once the 0100 message is received at the PNIP 2012 of the acquirer 2006, a series of edits can be performed on the transaction with respect to format, content, and/or context. Furthermore, screening can be carried out to determine whether the message relates to something beyond an ordinary authorization request, referred to as an enhanced service. Enhanced services may be screened for on behalf of one or more issuers 2010 and/or the operator of network 2008 itself. A centralized member parameter system (MPS) 2018 can be provided to house parameters used to drive processing of credit authorization transactions. In one or more embodiments, extracts from the centralized member parameter system 2018 are distributed to all acquirer PNIPs 2012 and issuer PNIPs 2024 on the network 2008 on a daily basis to drive processing of credit card transactions.

It should be noted at this point that an “ICA” and a “BIN” are employed in BANKNET so that a member can perform card issuing and/or acquiring activities. An ICA or Interbank Card Association is a four to six digit identification assigned by MasterCard for use by a member to uniquely identify activity the member is responsible for. A BIN or Bank Identification Number is a unique series of numbers assigned by MasterCard to a principal member and used as the first six digits of a cardholder account number. Other payment card networks have similar types of numbers, as will be apparent to the skilled artisan.

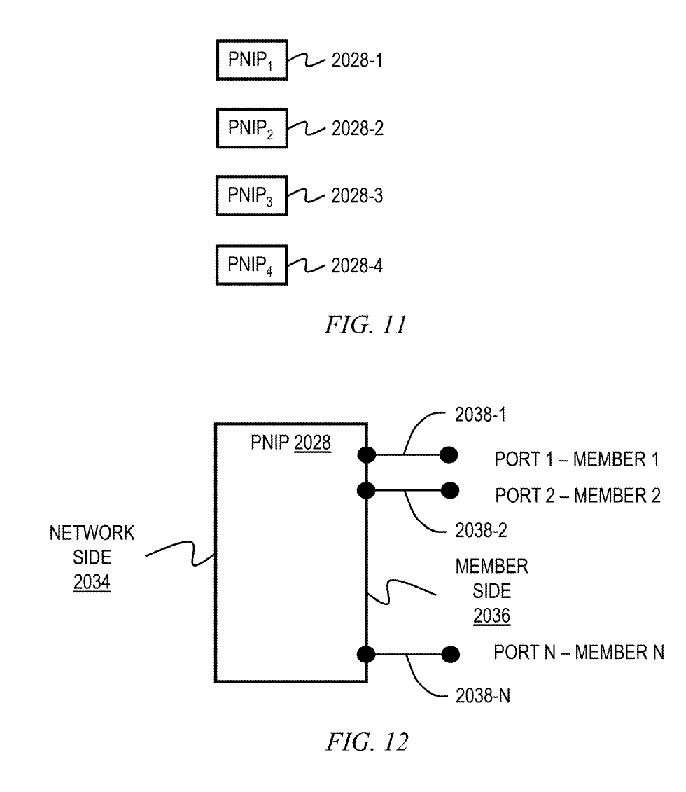

In at least some embodiments, the same member parameter extract is sent to all PNIPs and transactions are routed using same. In at least some circumstances, account numbers or ranges of account numbers are used in deciding how to route. In some cases, transactions are routed to an issuer PNIP based on where the account range is “signed in.” Issuers send an MTI 0800 sign in request message with either a group ID or account range. The Member ID is pulled from the PNIP port 2038 configuration and transactions from that account range are then routed to the port from which the sign-in request is received. A member ID can be present on ports on multiple PNIPs at an Issuer site—see discussion of FIG. 12 below.

In one or more embodiments, based on the account range, the parameters in MPS 2018 (or a local extract thereof) will determine how to process a given transaction; e.g., product code, country code, currency code, and the like, including what enhanced services (if any) the issuer has signed up for on a particular account range. That is to say, the messages are parsed and certain fields, including the account range, are examined; the account range is associated with a certain issuer and based on that, the message may be treated differently. Messages may be parsed, and converted into an internal data format so that access can be obtained to all the individual data elements. In one or more embodiments, the account number is used as a key to access the MPS 2018 (or a local extract thereof) and retrieve all the parameters that are appropriate for processing the given transaction. In a non-limiting example, a suitable message parser 2020 (and other programs on the PNIP 2012) can be written in an appropriate high-level language or the like.

In an exemplary embodiment, the central MPS 2018 creates extracts once a day that are distributed out to the endpoints on the network (e.g., PNIPs 2012), as seen at 2022. These extracts include the pertinent information needed for the PNIP to process the message and determine if it requires any special handling. In some instances, messages are next routed to a central site 2009 for performance of enhanced services. On the other hand, if no special services are required, the message may be routed directly to the issuer PNIP 2024 as seen at 2026.

Messages routed directly to the issuer PNIP: In this aspect, the transaction is routed directly to the issuer PNIP 2024 based on the MPS extract 2022, as seen at 2026. Every account range will have a unique destination endpoint identified in the parameters (account ranges may be grouped and all members of the account range group may have a common destination endpoint). The member interface refers to the connection between the acquirer processor 2006 and the Acquirer PNIP 2012. This term also applies to the interface between the Issuer PNIP 2024 and issuer processor 2010. The connections between and among acquirer PNIP 2012 and issuer PNIP 2024, acquirer PNIP 2012 and ASPs 2050, and ASPs 2050 and issuer PNIP 2024 are referred to as a network interface onto the payment card network itself (elements 2050 are discussed below). In one or more embodiments, this may be a TCP/IP connection (as seen at 2026) with customized routing capabilities including group addresses. Normally, TCP/IP addresses refer to a single endpoint. Group addresses may be directed to a group of addresses, and will target any of the computers (e.g., PNIPs) in the group using a variety of protocols. Some use a round robin approach; others may use a first in list approach where the message is always routed to one given computer first and then to a second computer only if the first is not available. Group addressing may be useful, for example, where an acquirer or issuer has multiple PNIPS at the same location for redundancy/fault tolerance. It is also possible to combine the approach and institute a round robin, wherein the addresses within the round robin are first in list group address, or conversely, it is possible to institute a first-in-list, wherein the addresses within the first-in-list are round robin group addresses. These capabilities are useful in case of outages, maintenance, and the like.

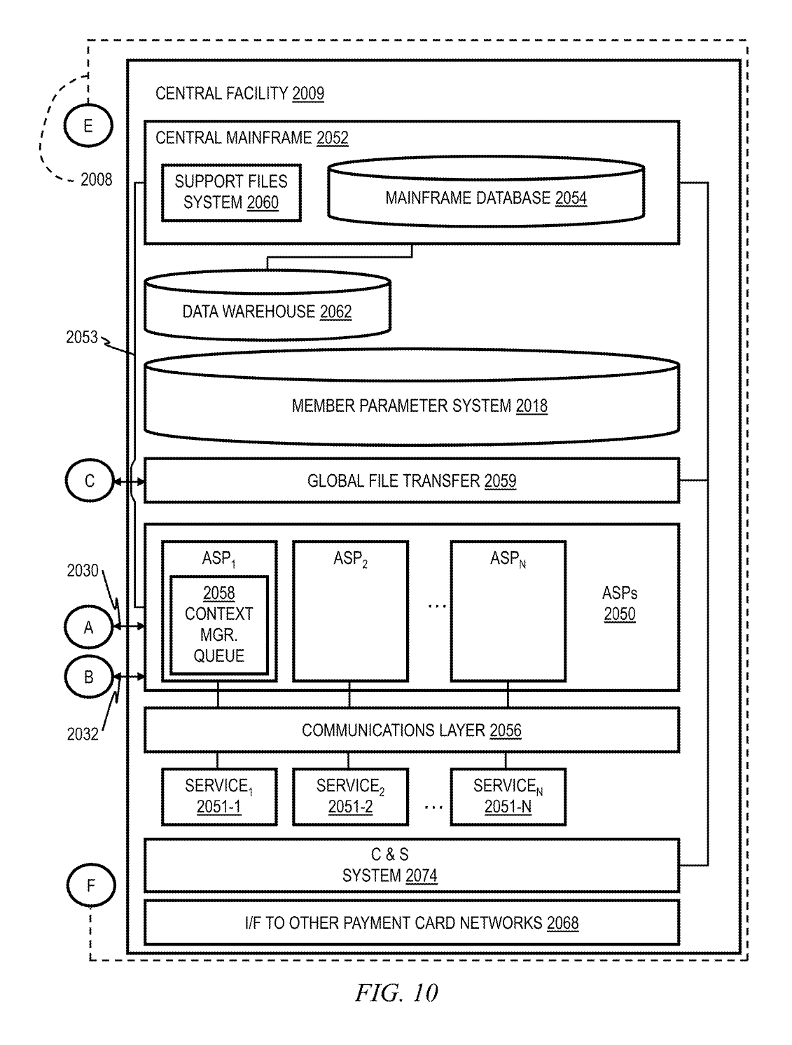

FIG. 11 shows a non-limiting example with four PNIPs 2028-1 through 2028-4. In a round robin approach, a first message is routed first to PNIP 2028-1, a second message to PNIP 2028-2, a third message to PNIP 2028-3, a fourth message to PNIP 2028-4, a fifth message to PNIP 2028-1, and so on. In a first in list approach, all messages are routed to PNIP 2028-1; if it is not available for a given message, the message is routed to PNIP 2028-2; if PNIP 2028-2 is not available, the message is routed to PNIP 2028-3; if PNIP 2028-3 is not available, the message is routed to 2028-4. Each PNIP 2028-1 through 2028-4 in FIG. 11 could be a single machine or a group of machines addressed by first in list or round robin as discussed just above. In one or more embodiments, the physical network 2026 between PNIPs 2012, 2024 and the physical network 2030, 2032 between PNIPs 2012, 2024 and the central site 2009 is a private Multiprotocol Label Switching (MPLS) TCP/IP network and is not the Internet. Once the issuer's network group address has been determined by the PNIP 2012 (or ASP 2050), the message is routed to the issuer PNIP 2024. Once the 0100 auth message arrives at the issuer PNIP 2024, additional edits are performed to double check and make sure that the message has been routed to the correct location. Furthermore, the member ID is examined, because some issuers may share a single PNIP and it is necessary to determine which of the issuers (members) sharing that PNIP the transaction in question is to be routed to. Each of the issuers sharing the PNIP will have its own port on the member side of the PNIP; the transaction is routed to the appropriate port based on the member parameters. See FIG. 12 where a generalized PNIP 2028 has a network side 2034 and a member side 2036. Member side 2036 has N ports 2038-1 through 2038-N to members 1 to N. N is used herein as a generalized arbitrary integer and the value of N in FIG. 12 is not necessarily the same as that of N in connection with elements 2002 in FIG. 2, for example.

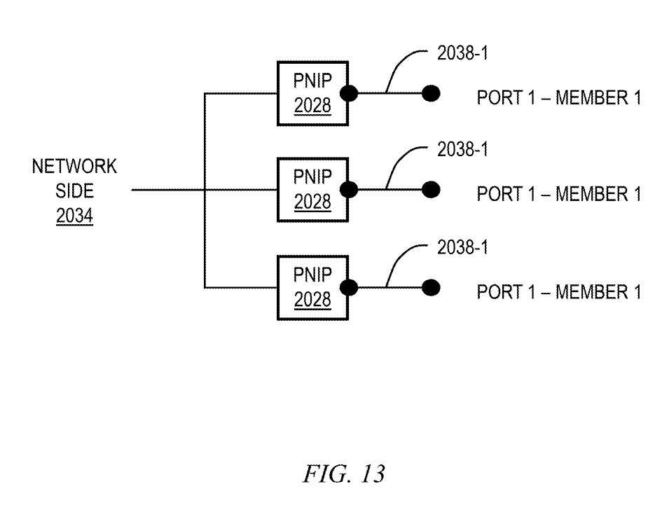

As seen in FIG. 13, in some instances, an issuer has multiple PNIP devices 2028 at a single site, with a network-side connection 2034, and with multiple PNIPs 2028 all connected to the same host system (each has port 1 2038-1 associated with the same member (issuer)).

At this point, the 0100 message has been delivered to the issuer 2010. The issuer 2010 then carries out issuer processing and decisioning (e.g., with issuer processing platform 2040) based on transaction velocities, open to buy, fraud detection protocols, etc., and provides an appropriate authorization request response, ISO 8583 MTI 0110. There are a number of different possible response codes defined within ISO 8583 and its particular implementations. Each transaction is made up of multiple data elements; the response from the issuer is included in data element 39. Once the 0110 message is received on the issuer PNIP 2024 from platform 2040 it is parsed and edited for format, content, and context, including validation of DE39 to make sure that it is a valid value.

It is worth noting that in one or more instances, at every point where a transaction touches a computer of the payment card network, whether it be an acquirer PNIP 2012, issuer PNIP 2024, or a special services computer or computers 2050 at the central location 2009 (discussed below), transaction context is preserved. That is to say, before the message is sent on to the next node in the network, a copy is saved in a context manager queue 2042, 2046, 2058, so that when the transaction response MTI 0110 comes back through, the request MTI 0100 can be matched with the response, in order to know how to route the response back to the previous route point. One of the items saved in the context manager queue is the message originator's address, so that it can be used for route-back information. Once the issuer PNIP validation is complete, including format, content, and context edits, the transaction is extracted from the context manager queue 2046 and the route-back address is retrieved, and the 0110 message is then sent back where it came from; in this case, the acquirer PNIP 2012 (or ASP 2050). The acquirer PNIP 2012 then receives and parses the message and pulls its original request out of its context manager queue 2042. Note that multiple acquirers may share an acquirer PNIP and it is therefore necessary to know which port on the acquirer PNIP to route the response back to (see discussion of FIG. 12). Checking the message against the original request in the context manager queue allows the message to be routed back to the correct port.

Each PNIP 2012, 2024 typically has many different programs. These can include, for example, a parser/editor 2020, 2043; a parameter file manager; a transaction context manager; a member communications program; a network communications program; and the like. Please note that to reduce clutter, FIGS. 9 and 10 show “MPS extract” 2022, 2044; this will typically include the extract itself and the associated parameter file manager which manages obtaining the extracts from MPS 2018. Similarly, to reduce clutter, FIGS. 9 and 10 show “context manager queue” 2042, 2046; this will typically include the queue itself and the associated manager which manages the contents of the queue. In one or more embodiments, there is also a communication program used to communicate between the other programs (inter-process communications) on the PNIP; this is omitted from FIGS. 9 and 10 to avoid clutter.

Messages in case of Enhanced Services: In one or more instances, a special architecture is used to facilitate delivery of enhanced services (the ASP 2050 in FIG. 10 is a non-limiting example). Examples of enhanced services include the MASTERCARD IN CONTROL product providing spending controls and/or virtual card numbers (MASTERCARD IN CONTROL is generally representative of spend control systems, card control systems, and the like, and embodiments indicated as employing MASTERCARD IN CONTROL are not intended to imply any limitation to one particular spend control and/or card control system). Other examples of enhanced services are loyalty rewards, recurring payment cancellations, and the like. One or more instances do not deploy this complex logic out to the network edge. Furthermore in this regard, the issuer and acquirer PNIPs 2012, 2024 are referred to as being on the edge because they reside on the customer's premises 2006, 2010. There may be over 2000 PNIPs on a typical network. The special architecture used in one or more instances is a central site type architecture associated with location 2009. At the central site 2009, certain computers are referred to as authorization services processors or ASPs 2050.

On the acquirer PNIP 2012, when checking the member parameter file for an account range, determine whether the transaction requires enhanced services. If yes, the transactions is routed to the central site ASPs 2050, which have interfaces to all of the service provider systems—the ASPs do not necessarily provide the services themselves (although they can in some embodiments), but may mediate between the network (e.g., BANKNET) and the actual service providers 2051-1 through 2051-N. An ASP will typically have connections 2053 to a mainframe 2052 via DB2 connect or other suitable connection. If a transaction is to be enriched with additional data, a database call will be made to the mainframe 2052 to retrieve the information from mainframe database 2054 so that it can be inserted into the transaction before the transaction is forwarded to the issuers. Interfaces can also be provided to a risk management system, a decisioning management system, MASTERCARD IN CONTROL, rewards, and the like. Service providers 2051-1 through 2051-N generally represent any enhanced services, non-limiting examples of which have been given herein.

A communications layer 2056 is used to communicate with the service providers in one or more embodiments, a non-limiting example of a suitable implementation is the IBM MQ series. The 0100 message may be sent to the service providers, optionally encapsulated inside a special “enhanced services” (ES) header that wraps the message with any additional information required to fulfill the service. The service provider sends a response. The ASP takes the response and enriches the 0100 transaction with the service response, and then sends the entire package on to the issuer PNIP 2024. Some enhanced services are processed on the request messages (0100) and others are processed on the response messages (0110). Once the response message is processed on the ASP, the original message will be pulled from the context manager queue 2058 on the ASP to determine the appropriate acquirer PNIP 2012 to route the message back to. From there, the acquirer PNIP will behave just as in the “Messages routed directly to the issuer PNIP” case discussed above. Some embodiments of the special architecture use an Enterprise Service Bus to mediate and facilitate some of the services 2051. For example, the MASTERCARD IN CONTROL service can be accessed via an instance of an Enterprise Service Bus.

Entry of Data into the Data Warehouse: In one or more instances, every transaction that flows through the issuer PNIP 2012, acquirer PNIP 2024, and/or ASPs 2050 is logged at every point by writing log records. Multiple times a day (e.g., six), a global file transfer system 2059 pulls the logs off each node and collects them into a support files system 2060 on the mainframe 2052. The log files are parsed and collected into a general daily file. The general daily file is scrubbed and modified to create a consolidated file on the mainframe which is then pulled into the data warehouse 2062, where additional data manipulation and scrubbing are performed before the transactions are stored. The data warehouse 2062 is located at an intermediate node (location 2009) connected to the PNIPs of the acquirers and issuers 2012, 2024. By way of clarification, in one or more embodiments, the node 2009 is directly connected to the PNIPs 2012, 2024 but the data warehouse is not directly connected to the 2012 and 2024 devices; rather, data flows through GFT and SF systems 2059, 2060 and ends up in the data warehouse. Data warehouse 2062 should be distinguished from a data warehouse 154 that might be maintained by an issuer.

Clearing and Settlement:

One or more instances employ a clearing and settlement system 2074. In clearing, via global file transfer 2059, acquirers submit clearing files in an appropriate message format (in a non-limiting example, Integrated Product Messages (IPM) format). The files contain, from the acquirers' perspective, what they believe they should be paid for. In one or more instances, the authorization does not actually move any money; the authorization only validates that the cardholder is a valid cardholder recognized by the bank, which will honor payment to the merchant for the goods or services. For example, in a typical restaurant visit, the card is swiped for the receipt amount but then a tip is added. The clearing message will have the actual food amount plus the tip. In one or more instances, the clearing does not actually move the money; it merely resolves the actual amounts. The settlement system actually initiates movement of the money. Furthermore in this regard, the settlement system actually tells the banks how much money to move but does not actually move the money. Within clearing, processes include dispute resolution, chargeback, and the like. During clearing, files are sent from the acquirers to the payment card network; the payment card network, using clearing and settlement system 2074, then takes the files and splits them and sorts them by issuer. Response files are then received from each issuer, and these response files are again split and re-sorted back to the correct acquirers. Eventually, data flows into the settlement system and money is moved. Thus, at a high level, the auth request and auth request response are in real time, and the clearing and settlement are in a batch mode.

By way of review and provision of additional detail, in at least some instances, in a batch mode, clearing is initiated via an ISO 8583 MTI 1240 message having a DE24 function code value of 200 for a first presentment. Once this message is obtained from the acquirer, the payment card network, using clearing and settlement system 2074, will undertake syntax edits, format edits, content edits, and context edits (typically applied to every transaction). If those edits are passed, the interchange and fees associated with the transaction will be calculated. Based on the calculations, the message may also be enriched with additional information before being passed on to the issuer. The settlement amount is then determined. Within the clearing cycle, the amounts of money due to each given member (e.g., issuer or acquirer) are accumulated, and these are summed up into a settlement file which is forwarded in due course.

Cryptographic Aspects:

Consider the concepts of data at rest and data in motion. An example of data at rest is the log files that actually reside on the PNIPS themselves—configuration information containing card numbers or personally identifiable information (PII). In one or more embodiments, all sensitive data at rest is encrypted before being written to disk. Data in motion refers to data actually moving over a transmission medium (e.g., wires, coaxial cable, fiber optic cable, RF link). All PCI-sensitive data (PCI Security Standards Council, LLC, Wakefield, Mass. US) is encrypted, whether written to disk or being sent over a network. In at least some instances, internal links within the premises of the acquirers and issuers are not encrypted since it is assumed that the customer premises are a physically secure facility relying on physical security of the hardware. On the other hand, in at least some instances, external links (e.g., links 2026, 2030 and 2032) are all encrypted for both authorization traffic and bulk file transfers.

One or more embodiments will have interface(s) 2068 to other brands of payment card processing network. For example, a MASTERCARD branded payment card processing network may have interfaces to networks such as AMERICAN EXPRESS, VISA, JCB, DISCOVER, and the like. Suitable translation layers can be provided to intermediate between MASTERCARD (or other) format and formats used by other networks, as appropriate. In one or more embodiments, interfaces 2068 to other payment networks are provided via a machine, located at 2009, but generally analogous to an Issuer PNIP 2024 with added mediation layers loaded as required by other payment network formats. Some merchants may only have a single interface to, e.g., the MASTERCARD network—all transactions from that merchant may be routed to MASTERCARD, regardless of what card was used—MASTERCARD will process those transactions and route them out to the appropriate networks.

While payment card networks have generally been used as described with regard to FIGS. 1 and 2, recently, MasterCard MONEYSEND (mark of MasterCard International Incorporated, Purchase, N.Y., US) money transfer services have provided a new dimension. A funding transaction moves money from the sender (customer) to the Originating Institution (the financial institution providing the money transfer service); that transaction can be initiated through a MONEYSEND application program interface (API). The sender can fund the transaction using a MasterCard card account or other branded card account that the Originating Institution accepts; from a bank account; with cash; or with a mobile money stored value account. A Payment Transaction transfers funds from the Originating Institution, via the MasterCard Network (e.g., BANKNET), to the payment card account identified by the recipient at the Receiving Institution. Funds can be transferred to a MasterCard® card, Debit MasterCard® card, and the like (marks of MasterCard International Incorporated, Purchase, N.Y., US). Such transactions are discussed further below and are an example of what are more generally referred to herein as special payment transactions.

Electronic Bill Presentment and/or Payment Systems

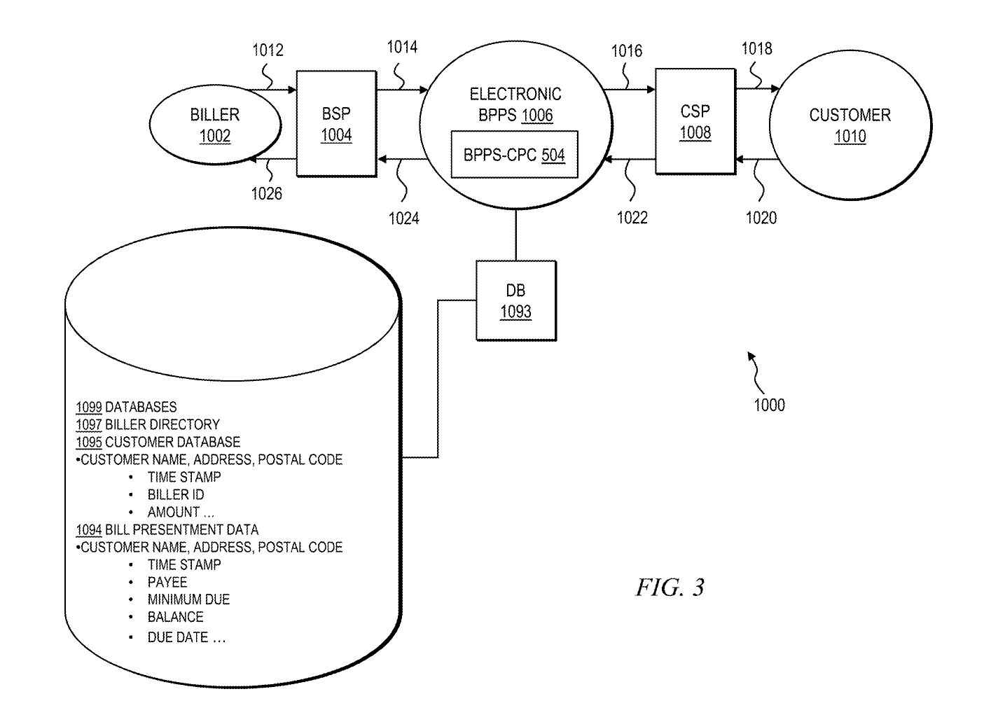

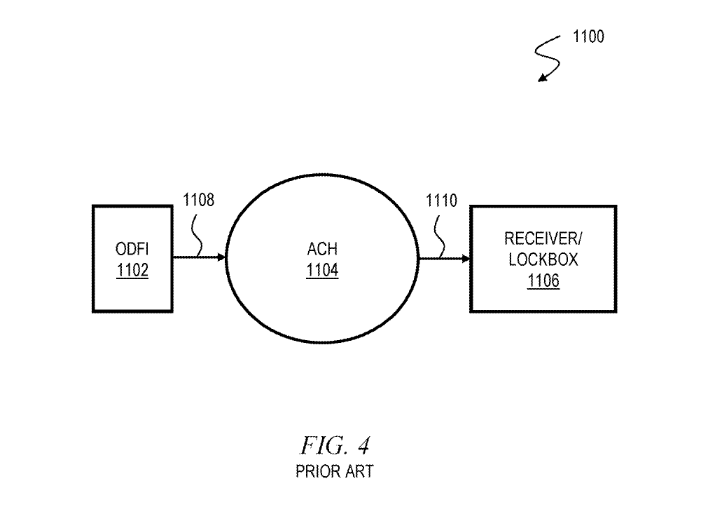

Referring now to FIGS. 3 and 4, electronic bill payment systems are conceptually different than payment card networks, and will often use electronic funds transfer from a demand deposit account. In some instances, a single entity, such as MasterCard International Incorporated (a non-limiting example) will operate both a payment card network and an electronic bill payment system (optionally, with presentment functionality).

With regard to electronic bill presentment and payment systems, inventive techniques can be employed in a number of different environments. In one or more embodiments, inventive techniques can be employed in connection with the MASTERCARD RPPS® electronic payment system of MasterCard International Incorporated of Purchase, N.Y., USA. This example is non-limiting; for example, other types of electronic bill presentment and/or payment systems could be employed in other instances. Non-limiting examples are described in:
US Patent Publication 2011-0251952 A1 of Mary L. Kelly et al.
US Patent Publication 2012-0197788 A1 of Hemal Sanghvi et al.
US Patent Publication 2013-0290177 A1 of Amy Christine Milam and Stephen Joseph Klaus.
US Patent Publication 2013-0311362 A1 of Amy C. Milam et al.

The above-listed Kelly et al., Sanghvi et al., Milam/Klaus, and Milam et al. publications are hereby expressly incorporated by reference herein in their entireties for all purposes.

For the avoidance of doubt, references to MasterCard, unless expressly stated to be limited to MasterCard, are intended to be exemplary of an operator of an electronic bill payment system (optionally, with presentment functionality) and/or an operator of a payment card network, as will be appreciated from the context, whether or not qualified by words such as “or other operator.”

Furthermore, another non-limiting example of electronic bill presentment and/or payment systems with which one or more embodiments of the invention can be employed is the CHECKFREE platform available from Fiserv, Inc. of Brookfield, Wis., USA. Other non-limiting examples are discussed below and/or will also be apparent to the skilled artisan, given the teachings herein.

FIG. 3 shows operation of an electronic bill payment system, such as the MASTERCARD RPPS® electronic payment system, which is but one non-limiting example of such a system, modified in accordance with aspects of the invention. Given the teachings herein, the skilled artisan will be able to implement one or more embodiments of the invention using a variety of techniques; by way of example and not limitation, the modification or supplementing of an existing MASTERCARD RPPS® system or other electronic payment system as shown in FIG. 3. As shown in FIG. 3, in an approach 1000, during a presentment phase, a biller 1002 electronically sends billing information 1012 to its biller service provider (BSP) 1004; that is, an institution that acts as an intermediary between the biller and the consumer for the exchange of electronic bill payment information. BSP 1004 in turn sends the information to the electronic bill payment system 1006, as seen at 1014. As seen at 1016, the system 1006 in turn delivers the billing information to the customer service provider (CSP) 1008, that is, an agent of the customer that provides an interface directly to customers, businesses, or others for bill payment and presentment. The CSP enrolls customers, enables payment and presentment, and provides customer care. CSP 1008 presents the bill to the consumer (customer) 1010 at 1018.

In a payment phase, consumer 1010 sends bill payment instructions to CSP 1008, as seen at 1020. CSP 1008 in turn sends the bill payment information to the system 1006, as at 1022. The system sends funds and data electronically to BSP 1004, as at 1024. The BSP 1004 posts payment information to the biller 1002, as at 1026.

Note that in some instances, billers 1002 can connect directly to BPPS 1006 without the use of BSP 1004. In such cases, billers 1002 exchange presentment and payment data directly with BPPS 1006.

Database(s) 1099 include biller directory 1097, customer database 1095, and/or bill presentment database 1094; databases 1097, 1095, and 1094 can be accessed by BPPS 1006 via a suitable database program 1093. MasterCard's RPPS Biller Directory is a non-limiting example of biller directory 1097. Each biller in the biller directory is identified by a unique Biller ID. In some instances, this Biller ID can be the same as the unique merchant identifier discussed below; in other instances, the unique merchant identifier discussed below can be different and can also be stored in biller directory 1097 or elsewhere. Records in the biller directory 1097 will also typically include the name and address information for the biller corresponding to the Biller ID, as well as, in the conventional case, the biller's demand deposit account to which payments should be routed. In one or more embodiments of the invention, instead of or in addition to demand deposit account information, a payment card account number of the merchant, which can receive payments (e.g., via special payment transaction discussed herein), can be stored. Of course, other embodiments could use a different database configuration than that shown and described herein. Customer database 1095 includes, in one or more embodiments, the customer's name, address, and postal code, and for each payment, time stamp for the payment, Biller ID, and amount. In a non-limiting example, bill presentment can be carried out via a web site operated by an underlying bank. The bank will typically have a Party ID and Party Collection ID. The Party ID will identify unique individuals. The Party Collection ID will be for a household including one or more individuals. Thus, customer database 1095 can include household IDs with associated data and individual IDs with associated data. It should be noted that in some cases, some data referred to as residing in customer database 1095 (e.g., customer's home address) may be maintained by customer service provider(s) 1008 rather than electronic BPPS 1006; database 1095 may thus, in some cases, be implemented as a composite of several databases maintained by customer service provider(s) 1008 and electronic BPPS 1006. Bill presentment database 1094 may include “raw” presentment data. A non-limiting example of bill presentment data such as would typically be available in database 1094, representing bill presentment as described with regard to 1012, 1014, 1016, 1018, includes Time Stamp, Payee, Minimum due, Total Balance, and Due Date. Of course, there would be many users of the electronic BPPS, and there would typically be many bill presentment records for each user.

As discussed below, one or more embodiments are implemented in connection with a BPPS as described with regard to FIGS. 3 and 4; however, a small business (merchant) 683 may or may not be a biller 1002 and customer (buyer) 695 may or may not be a customer 1010. That is to say, a merchant and customer using one or more mobile payment embodiments disclosed herein may or may not otherwise be conventional users of the BPPS.

Note that “BPPS” is used herein as shorthand for an electronic “bill presentment and payment system”; the MASTERCARD RPPS system is a non-limiting example of such a system. Furthermore, new functionality from a new bill presentment and payment system card payment component (BPPS-CPC) 504 interfacing with a mobile open payment network, according to aspects of the invention, is discussed below.

FIG. 4 shows a current process 1100 for making electronic funds transfers (EFT) for bill payment or the like. An originating depository financial institution (ODFI) 1102, also known as an originator, sends instructions (e.g., payment data and remittance data) using a network such as the automated clearing house (ACH) 1104, Swift, EPN, CHIPS, Fedwire, and the like, as seen at 1108. As shown at 1110, the ACH or similar network 1104 relays the instructions to the receiving depository financial institution (RDFI) (e.g., receiver or a lockbox), designated 1106. In some embodiments, an ACH file format can be used; one non-limiting example of an ACH file format is the NACHA ACH CCD file format. Other formats can also be used; for example, extensible markup language (XML). It should be noted that a variety of networks can be used, both public (for example, ACH) and proprietary (for example, the aforementioned MASTERCARD RPPS system).

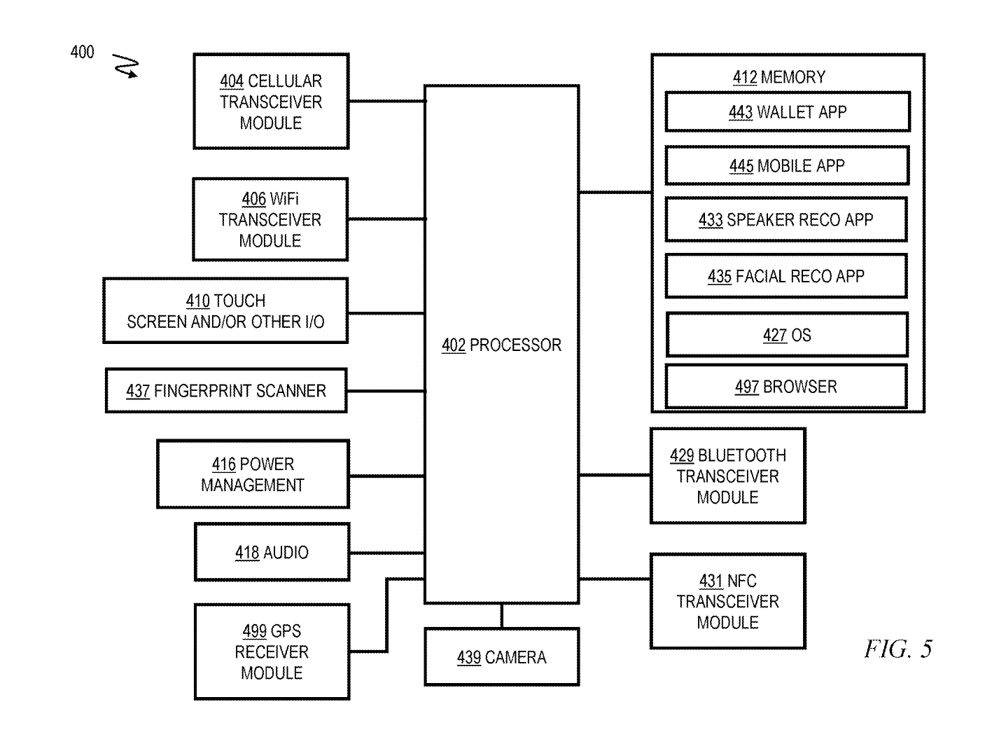

As used herein, an “electronic bill presentment system using customer service providers” refers to a system wherein electronic bills are distributed from billers, through an aggregator switch, out to financial institutions or other customer service providers such that those financial institutions or other customer service providers can display the electronic bills, through the financial institutions' or other customer service providers' own on-line banking interface, to bill-paying customers of the financial institutions or other customer service providers. FIG. 5 of the above-referenced US Patent Publication 2011-0251952 A1 of Mary L. Kelly et al. shows an exemplary block diagram of an electronic bill presentment system, including a bill payment platform and a bill presentment platform; the bill payment platform may utilize techniques disclosed in the above-referenced US Patent Publication 2012-0197788 A1 of Hemal Sanghvi et al.

Some electronic bill payment systems use the NACHA ACH Standard Entry Class (SEC) formats, such as CIE (Customer Initiated Entries), CTX (Corporate trade exchange); CCD (Cash Concentration or Disbursement); or PPD (Prearranged payment and deposits). Some electronic bill payment systems use a modified form of the NACHA CIE (MOD-CIE) wherein a payment system operator requires specific values for certain fields. Some electronic bill payment systems (e.g., MASTERCARD RPPS) provide translation capability and can receive input in many different formats, translate it for internal use, and translate it again for output in many different formats, which may be the same as or different from the input formats. Some electronic bill payment systems provide customer service providers with the capability to specify when the electronic bill payment system will look to them for payment instructions. Some electronic bill payment systems provide biller service providers with the capability to specify when the electronic bill payment system will initiate payments. FIG. 5 of the above-referenced US Patent Publication 2012-0197788 A1 of Hemal Sanghvi et al. shows exemplary system interfaces of an electronic bill payment system.

As noted above, electronic bill presentment and payment systems are conceptually different than payment card networks, and will often use electronic funds transfer from a demand deposit account. Nevertheless, some electronic bill presentment and/or payment systems receive and send data over a network such as is shown in FIG. 2, using capability such as MasterCard Global File Transfer (GFT). Furthermore, US Patent Publication 2010-0100480 of Theresa Altman et al., hereby expressly incorporated by reference herein in its entirety for all purposes, describes a system wherein payment of a bill using a payment card account is facilitated by formatting and dispatching a message from a bill payment provider to an electronic bill payment system. The message is flagged with a flag indicating that the message includes a non-financial, card payment, message. The message includes an identification of the biller, a card number of the payment card account, and an expiration date of the payment card account. The message is an electronic funds transfer message augmented with the flag, the card number, and the expiration date.

Some electronic bill payment systems use technology such as described in the above-referenced US Patent Publication 2013-0290177 A1 of Milam and Klaus to reduce the number of non-electronic payments. Some electronic bill payment systems use technology such as described in the above-referenced US Patent Publication 2013-0311362 A1 of Amy C. Milam et al. to facilitate approximately matching entered payee information to stored biller information.

### Exemplary Mobile Device(s)

FIG. 5 is a block diagram of an exemplary tablet computing device, netbook, “Ultrabook” or other subnotebook, laptop, mobile electronic device, or smart phone 400 or the like. Unit 400 includes a suitable processor; e.g., a microprocessor 402. A cellular transceiver module 404 coupled to processor 402 includes an antenna and appropriate circuitry to send and receive cellular telephone signals, e.g., 3G or 4G. In some cases, a Wi-Fi transceiver module 406 coupled to processor 402 includes an antenna and appropriate circuitry to allow unit 400 to connect to the Internet via a wireless network access point or hotspot. The skilled artisan will appreciate that “Wi-Fi” is a trademark of the Wi-Fi Alliance and the brand name for products using the IEEE 802.11 family of standards. In some cases, a Bluetooth transceiver module 429 coupled to processor 402 includes an antenna and appropriate circuitry to allow unit 400 to connect to other devices via the Bluetooth wireless technology standard. In some cases, an NFC transceiver module 431 coupled to processor 402 includes an antenna and appropriate circuitry to allow unit 400 to establish radio communication via near-field communications.

Operating system (OS) 427 orchestrates the operation of unit 400. Apple's iOS and Google's Android are non-limiting examples of suitable operating systems.

Touch screen 410 coupled to processor 402 is also generally indicative of a variety of input/output (I/O) devices such as a keypad, another type of display, a mouse or other pointing device, and so on, all of which may or may not be present in one or more embodiments. Audio module 418 coupled to processor 402 includes, for example, an audio coder/decoder (codec), speaker, headphone jack, microphone, and so on. Power management system 416 can include a battery charger, an interface to a battery, and so on. Memory 412 is coupled to processor 402. Memory 412 can include, for example, volatile memory such as RAM, and non-volatile memory such as ROM, flash, or any tangible computer-readable recordable storage medium which stores information in a non-transitory manner. Processor 402 will typically also have on-chip memory. In some cases, fingerprint scanner 437 is coupled to processor 402 for biometric authentication purposes. An appropriate corresponding software application (not separately depicted) may reside in memory 412 in some instances. A digital camera 439 is coupled to processor 402. In some embodiments, camera 439 is used in conjunction with a facial recognition application 435 in memory 412 for biometric verification. In some embodiments, a microphone in audio module 418 is used in conjunction with a speaker recognition application 433 in memory 412 for biometric verification; a suitable acoustic front end can be provided.

A GPS receiver module 499 coupled to processor 402 includes an antenna and appropriate circuitry to allow device 400 to calculate its position by precisely timing the signals sent by GPS satellites high above the Earth. Corresponding software optionally resides in memory 412.

Memory 412 can also include, for example, a stored PIN for comparison with a PIN entered via touch screen 410; extracted facial features from the legitimate owner of the phone for comparison with facial features extracted from a picture taken by camera 439; extracted fingerprint features from the legitimate owner of the phone for comparison with fingerprint features obtained from a scan carried out by scanner 437; and/or extracted voice features from the legitimate owner of the phone for comparison with voice features extracted from a voice sample obtained from a microphone in audio module 418. Note that elements in FIG. 5 are shown connected directly to processor 402; however, one or more bus structures can be employed in one or more embodiments. Furthermore, elements shown as implemented in software may be implemented at least in part in hardware for speed, if desired.

Browser program 497 in memory 412 deciphers hypertext markup language (html) served out by a server for display on screen 410 or the like.

Every instance need not necessarily have every feature depicted in FIG. 5.

### Mobile Open Payment Network and Exemplary Implementation Thereof Via an Electronic BPPS or the Like

In one or more embodiments, an electronic bill payment system, optionally with presentment functionality, is expanded to settle real-time with small businesses using a special transaction (e.g., ISO-8583 message type 0100 with transaction type twenty eight, or an ISO-8583 message type 0200 with transaction type twenty eight), such as the MasterCard MONEYSEND Payment Transaction, in place of existing ACH and Wire transfer payments. Additionally, one or more embodiments provide the capability for businesses to register for the service with a mobile telephone company (“Telco”) or the like, which in turn interacts with an entity such as MasterCard directly or through a sponsor bank.

Furthermore in this regard, one or more embodiments expedite the receipt of funds for business, by adding a new option for businesses to receive funds to their payment card accounts (e.g., MASTERCARD card or VISA card accounts) based on payments initiated via mobile phone. Today, businesses can receive online bill payments via an electronic bill payment system by ACH or wire transfer. Note that one or more embodiments are believed to be particularly useful for developing markets; however, this is not a limitation.

One or more embodiments provide a Mobile Open Payment Network. A suitable entity, such as MasterCard, provides an open card acceptance network to mobile telephony providers (“Telcos”). This network allows small sellers to register as card acceptors to receive mobile payments for goods and services from any Telco on the network. One or more embodiments advantageously reduce or eliminate the need for payment terminals and physical transmission of card numbers through physical cards, near-field communications (NFC) payments, and the like.

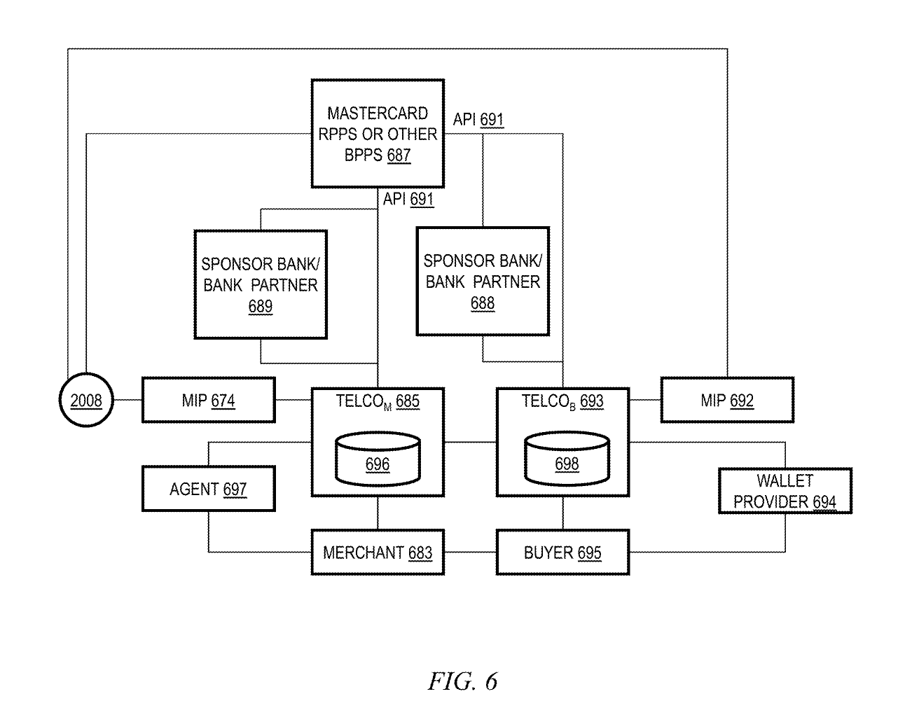

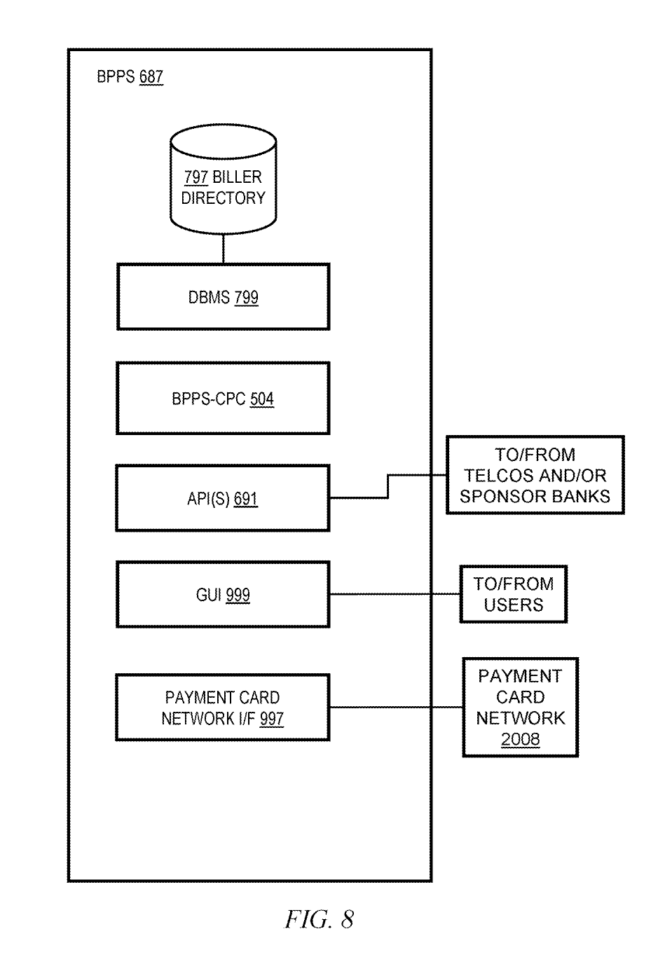

Referring now to FIG. 6, in a first step, a small seller (e.g., merchant 683) buys a mobile phone 400 with service from Telco_{M} 685. When the small seller 683 registers with Telco_{M} 685, he or she indicates that he or she is a seller and would like to join the MasterCard Network. This occurs, for example, during a simple registration on the mobile device 400 interacting wirelessly with Telco_{M} 685 or at an agent 697 (e.g., brick and mortar) of Telco_{M}. Telco_{M} 685 registers the small merchant 683 and the merchant's address with BPPS 687 (in at least some cases, BPPS 687 may be BPPS 1006) and follows all applicable anti-money-laundering (AML), know your customer (KYC), or other pertinent procedures on the small business. This is accomplished, for example, through a MasterCard API 691 which registers the small business in MASTERCARD RPPS or any other suitable bill presentment and payment system as described elsewhere herein. The MasterCard API 691 returns to Telco_{M} 685 a unique Merchant ID to identify merchant 683. Thus, in a non-limiting example, this first step is carried out with portable phone 400 (e.g., browser 497 or an app) communicating wirelessly with a server of Telco 685 which in turn communicates with MasterCard 687 via API 691 (wired or wireless). The registration information may be stored in directory 797 (see FIG. 8) and/or database 696. Any suitable technique can be used to assign unique Biller IDs; e.g., starting with a known number for the first biller and incrementing each successive biller by unity. As noted, the identifier of the merchant 683 for use with one or more mobile payment embodiments disclosed herein may or may not be the same as a conventional ID of the merchant as stored in biller directory 1097. Furthermore, in some embodiments, the Merchant ID could be a mobile phone number, such as the merchant's mobile phone number. Thus, a Biller ID may be generated and assigned during registration, or some existing number or alphanumeric string (e.g., mobile phone number or conventional ID of the merchant as stored in biller directory 1097) can be assigned (possibly at the request of the merchant; merchant could request use of merchant's mobile phone number as the ID, for example).

In a second step, the small seller 683 displays the Merchant ID at a suitable location in the premises; e.g., such as a sign on the counter (in some embodiments, this location is considered as a point of interaction (POI)).

In a third step, a customer (e.g., buyer 695) buys goods or services from the small seller 683. The small business 683 provides the customer 695 with the small business' MasterCard Merchant ID for payment (e.g., via the above-discussed sign) and also provides the customer with the amount due.

In a fourth step, the customer 695 uses phone 400 to text <Merchant ID><amount due> to the short code for MasterCard Payments. For example, the customer texts: Pymnt (shortcode) 123456 2.50 (assumes 2.50 in local currency). The customer can send this text with the aid of its Telco; here, Telco_{B} 693. In general, Telco_{B} 693 can be the same as or different from Telco_{M} 685. This text message can be received, for example, at a messaging server of Telco 693 or MasterCard 687 and parsed using appropriate text parsing techniques.

In a fifth step, a text message is sent to the customer 695 (e.g., from Telco_{B} 693) to confirm the merchant and amount. For example, the message may say “Confirm Payment to <Small business name>$2.50. Type Y to confirm, N to cancel.” Please note that the dollar sign “$” is exemplary and the appropriate symbol for the local currency can be used. The customer 695 types Y to confirm.

In a sixth step, the customer's Telco, Telco_{B} 693, deducts the payment amount from the customer's mobile account (e.g., pre-paid stored value in database 698; amount to be added to the Buyer's periodic phone bill on a credit basis). In one alternative approach, the customer registers a conventional payment card account with the customer's Telco, Telco_{B} 693, and the customer's Telco charges the payment amount to that card account using conventional payment card network functionality. In another alternative approach, rather than using database 698 to store value, the customer's Telco, Telco_{B} 693, establishes a stored value payment card account, similar to a virtual card number, to manage the customer's pre-paid stored value. Once the funds are secured, the message is routed to MasterCard 687 (e.g., the customer's Telco, Telco_{B} 693, via web API 691, instructs MasterCard 687 to originate a special payment transaction as discussed elsewhere herein to move the funds to the small business' payment card account in real-time via network 2008). In an alternative, Telco_{B} 693 has access to a payment card network such as via a PNIP or the like, and directly originates the special payment transaction. In any event, a real-time approval response is returned to the customer 695, indicating that payment is complete (e.g., via text message). The small business 683 receives a text message indicating that the payment is complete; for example, the text message states “Payment from <mobile number> for $2.50 has been deposited into your account.” Again, please note that the dollar sign “$” is exemplary and the appropriate symbol for the local currency can be used. These actions could also be accomplished on a smart phone via a mobile app or mobile web site.

Thus, the Consumer's Telco 693 may use API 691 to initiate transactions to make payment to the merchant. The consumer's Telco first secures funds from the consumer. The Telco may use a purchase transaction on the MasterCard Network or another network, or deduct funds from a stored value account.

In a seventh step, the Telco_{M} 685 deducts a fee from the account of small business 683 for receiving the payment (e.g., updating database 696) prior to sending payment to the business or after settlement. The Telco_{M} 685 pays a fee to MasterCard 687. MasterCard shares part of the revenue with the customer's Telco, Telco_{B} 693, for originating the payment.

In an alternative approach, in the sixth step, the message is routed to the small business' Telco_{M} 685 who originates the payment on the MasterCard network (e.g., 2008) directly through a MIP 674 or other PNIP (as discussed elsewhere herein) or through a MasterCard API 691. Please note that MasterCard API 691 may include several APIs; for example, for registration, payment initiation, and so on, and for interaction with different parties, such as 685 and 693.

Please note that small business (merchant) 683 may or may not be a biller 1002 and customer (buyer) 695 may or may not be a customer 1010.

Advantageously, one or more embodiments provide open-loop payments, in contrast to closed loop mobile payments wherein customers and merchants are on the same Telco. Also advantageously, one or more embodiments provide an open network using an inventive modification to the existing card network to enable card acceptance using any mobile phone, while reducing or eliminating need for terminals, physical cards, or NFC. At least some embodiments are not based on person-to-person (P2P) payments and/or are not based on stored value accounts (although the buyer 695 might maintain a stored value account with the Telco_{B} 693 (e.g., with balance in database 698) in some instances to fund the payments to the merchant(s) 683).

One or more embodiments provide a Mobile Open Payment Network that allows a Telco or Mobile Money (discussed further below) provider to accept merchant payments for registered merchants from any Telco or Mobile Money provider connected to the network. The Telco registers merchants with MasterCard and provides a Mobile Money account backed by a MasterCard card. The customer of a participating Telco initiates a customer payment simply by sending a text message with the Merchant ID and amount to make a payment. Payments are made securely with no account data shared.

Consider an exemplary Merchant Registration for Mobile Money Acceptance using text messaging. In a non-limiting example, the following preconditions apply. The service is offered by a Telco or mobile money provider. Each mobile money account is backed by a MasterCard prepaid or Debit card. The Telco has registered to provide merchant payment acceptance through MasterCard and has a sponsor bank or has registered with MasterCard as a Member to issue MasterCard cards. In a non-limiting example of registration, the Telco or provider gathers the necessary information from the merchant. This can be done, for example, through text messaging, via a mobile app 445 on a smart phone 400 or feature phone, or in person at the Telco 685 or its agent 697. Once all registration requirements have been met, the Telco or provider registers the Merchant with MasterCard via a Merchant registration API 691 and provides the merchant name, Government ID, address, and mobile phone information. MasterCard returns the Merchant ID that the merchant will provide to customers to accept payment. The following table shows an exemplary sequence of messages by the Telco 685 to the merchant 683, and the corresponding responses.

| | Merchant 683 (customer |
|---|---|
| Telco_{M} 685 | of Telco_{M} 685) |
| Do you want to register as a Merchant to | |
| accept payments? Y or N | |
| | Y |
| What is your company name? | |
| | Aneis' Food Market |
| What is your address? | |
| | 74 Bridle Street, . . . |
| What is your Tax ID? | |
| | 7374-384 |
| Type Y to accept Terms and Conditions. | |
| <url> | |
| | Y |
| Congratulations! You are registered. Your | |
| Merchant ID is 67355. Have customers | |
| short code 23411, Pay 67355 <amount> to | |
| make a payment. See <url> for more | |
| details. | |

Consider an exemplary Customer Payment for Mobile Money Acceptance using text messaging. In a non-limiting example, the following preconditions apply. The customer's Telco 693 or wallet provider has signed up with MasterCard to acquire transactions. The Telco or wallet provider has coded to the MasterCard API 691 to initiate transactions.

In a non-limiting example, to make a Payment, the merchant provides instructions to the customer as to how to make a payment. For example, a counter display includes a short code and Merchant ID. The skilled artisan will appreciate that short codes (also known as short numbers) are special telephone numbers, significantly shorter than full telephone numbers, which can be used to address SMS and MMS messages from certain service providers' mobile phones or fixed phones. There are two types of short codes: dialing and messaging. The equivalent for voice calls is known as abbreviated dialing. Text messaging, or texting, is the act of composing and sending a brief, electronic message between two or more mobile phones, or fixed or portable devices over a phone network. The term originally referred to messages sent using the Short Message Service (SMS). It has grown to include messages containing image, video, and sound content (known as MMS messages). The sender of a text message is known as a texter, while the service itself has different colloquialisms depending on the region. It may simply be referred to as a text in North America, the United Kingdom, Australia, New Zealand and the Philippines, an SMS in most of mainland Europe, and a TMS or SMS in the Middle East, Africa and Asia.

Now continuing, the customer authenticates to his or her mobile phone 400 in order to make the payment; for example, by entering a PIN or via biometric techniques (fingerprint, speaker reco, facial reco) as described elsewhere herein. The authentication is provided by the Telco 693 or provider. The customer initiates payment by sending Pay <merchant ID> and amount to the short code provided. The short code could be provided by the customer's Telco 693 or MasterCard 687. The customer's Telco calls a MasterCard API 691 to look up the merchant name for customer confirmation. The customer confirms the merchant and amount. The customer's Telco debits funds from the customer. If there are sufficient funds, the customer's Telco initiates a payment transaction to the MasterCard API 691. In at least some embodiments, no merchant account information is shared with the customer's Telco or the customer. The MasterCard network 2008 routes a payment transaction to the merchant's Telco 685. The merchant's Telco 685 approves the payment and the approval is routed to the customer's Telco 693. The customer's Telco 693 provides a payment confirmation to the customer 695. The merchant's Telco 685 provides an optional payment confirmation to the merchant 683. The following table shows an exemplary sequence of messages by the customer 695 to the customer's Telco 693, and the corresponding responses.

| Customer 695 | Customer's Telco, Telco_{B} 693 |
|---|---|
| <short code> 23411 Pay | |
| 67355 2.50 | |
| | Do you want to pay Aneis' Grocery $2.50? |
| Y | |
| | Your payment to Aneis' Grocery is |
| | confirmed. Confirmation# 36473 |

Further, the merchant can receive a message such as “36473 Aneis' Grocery received $2.50 payment from Sondaya.”

Some embodiments are based on a bill payment system such as shown in FIG. 3. One or more embodiments enable mobile payments in developing countries where many people have mobile phones but there are few or no payment card terminals or plastic payment cards (however, one or more embodiments can be used in other countries as well). One or more embodiments allow a customer to (i) buy goods and/or services from a merchant who owns a shop and (ii) be able to pay with the customer's mobile phone and mobile money account. One or more embodiments use the MasterCard network or similar network and have an open architecture.

In contrast to some solutions that are closed loop, where everyone has to have a wallet on the same system, one or more embodiments use the underlying card network (e.g., 2008) in an open way. Paying a merchant on a mobile phone in a developing country has some similarities to online bill payment, wherein it is not known how to reach the business that it is desired to pay. In one or more electronic bill presentment and payment systems (BPPS), the Payer merely advises the payment provider who it is that the Payer wishes to pay, and how much, and the payment provider takes care of the rest.

One or more embodiments are Telco-based and optionally utilize mobile wallet providers as seen at 694 (and see also mobile wallet app 443), and involve a buyer 695 and a merchant 683. One or more embodiments seek an easy way for a merchant to be acquired in developing markets; much more simply than current procedure in developing countries. In one or more embodiments, the merchant 683 simply approaches the Telco 685 and states “OK, I want to be a merchant and accept payments”—and in this simple way the merchant is able to accept payments with the system. Furthermore, the buyer 695 can very simply state to Telco 693 “I want to pay” and there will be an alias (ID) that allows the buyer to make a payment to the merchant. In one or more embodiments, the merchant's phone number may not be used; rather, a separate ID is used. However, other embodiments could utilize the merchant's phone number.

As used herein “Mobile Money” generally means that a Telco or provider has a wallet on the person's phone that contains funds for that person. Note that in a phone-based electronic wallet as currently used in the US, the individual opens the wallet and enters his or her credit and debit cards. In contrast, in the Mobile Money approach, the Telco or provider opens some kind of account behind the scenes, tied to the phone number—it could be, e.g., a stored value account or the merchant could maintain a MasterCard card account of some type.

In one or more embodiments, actual payment to small merchant 693 is made to the merchant's special payment card account that can receive funds via a special transaction. Once the merchant registers, the Telco 685 issues some kind of card to the merchant to receive funds.

In one or more embodiments, a Telco 685 registers with MasterCard 687 to acquire merchants such as merchant 683 in a given market. This Telco has also integrated with MasterCard as an issuer, so the Telco can carry out issuer processing (or this can be done through the Telco's bank partner 689). Telco 693 may also have a bank partner 688. Small merchant 683 may already have a phone or may be getting a phone for the first time; the small merchant desires to sign up to accept payments (in one or more embodiments, payments to a payment card of the merchant; however, other embodiments could utilize other kinds of payments). The Telco 685 carries out a text message exchange with the small merchant 683 to solicit registration, possibly as part of the small business getting a new phone. In this aspect, during the registration process, while signing up and providing whatever other information the Telco might prompt for in order to open a Mobile Money account, one of the questions to the merchant 683 could be “do you want to register as a merchant to accept payments?” to which the small business could reply “yes.” In response to the “yes,” the Telco 685 gathers whatever information it needs to identify the small business, carry out risk analysis, and complete the registration process; e.g., name of company, address, government ID, and so on. At the end, ask the merchant to accept the pertinent terms and conditions; then, finally, the Telco 685 advises the merchant 683 that the merchant is registered and the Telco 685 provides the merchant with the merchant's Merchant ID (basically, an alias to receive a payment), and some simple instructions to receive payments from the customer (e.g., tell customer to text short code, pay instruction, merchant ID, amount).

Thus, one or more embodiments include a registration phase, and then a use phase.

Actions described as being done by Telcos 685, 693 can in general instead be done by their corresponding sponsor banks 689, 688.

Furthermore with regard to registration, a non-limiting example has been provided using text messaging. Other embodiments could use other approaches; e.g., a smart phone application (“app”) 445, Wireless Application Protocol (WAP) app, through a paper form exchange with the Telco, or the like. When the Telco is ready to register the merchant, the Telco calls a MasterCard API 691 to provide the company information and to indicate that it is desired to register the merchant as an acquired merchant to accept payments. One or more embodiments utilize real-time merchant registration. At this point, the merchant has a Merchant ID and instructions regarding how to get paid. The customer can use any Telco mobile provider that can accept MasterCard payments in an open loop fashion. That is, Telco 693 need not be the same as Telco 685. Any Telco may be given the opportunity to sign up to be an acquirer and initiate payments on the network. Any kind of account that the Telco has can be used for the funding source—stored value, Visa, MasterCard, bank, etc. In one or more embodiments, the Telco or service provider that the Telco is working with has previously integrated with MasterCard to initiate these payments. Payment flow is advantageously easy for the customer to initiate: the customer merely has to text the short code, command identifier such as “pay,” merchant ID, and dollar (or other currency) amount. The Telco 693 does a lookup in the MasterCard system 687 (e.g., in Biller Directory 797) and obtains the name of the merchant 683 and potentially the address. There is a response back from the Telco 693 to the customer 695, “do you want to pay Aneis Grocery $2.50?” Basically, this is a payment confirmation. The customer says yes, and the Telco 693 initiates the payment on the network, using the ID 67355 and the dollar (or other currency) amount.

Telco 693 accesses a suitable database (e.g., Biller Directory 797 or local database 698); based on what Telco 693 looks up in the database they initiate an ISO 8583 special payment transaction to pay funds onto the merchant's card. Telco 693 may interface with network 2008 via MIP 692 or another type of PNIP, for example. A web-based equivalent (API equivalent 691, e.g.) can also be used in some instances. In one or more embodiments, submit the Merchant ID and card credentials. Current ISO 8583 special payment messages require putting in the receiving card account. In one or more embodiments, there is a merchant alias (merchant ID). Telco 693 could link into a web service that MasterCard 687 provides (i.e., in its role as a BPPS operator), in order to initiate the transaction in that manner. Ultimately, in this alternative approach, there is still an ISO 8583 special payment transaction over the BANKNET network 2008 or the like; however, instead of Telco 693 initiating it directly, it is initiated by Telco 693 indirectly via having a web connection with MasterCard 687, who initiates the ISO 8583 transaction into network 2008. The BPPS operator is, in one or more embodiments, equipped with a suitable payment card network interface 997, as seen in FIG. 8, which can be, for example, a MIP or other type of PNIP. MasterCard 687 obtains the merchant ID and looks up the merchant's card account and initiates the ISO 8583 special message. For example, access the Biller Directory 797 and the card account number matches the bank account and then when the transaction comes in, a look-up is carried out on the card account number and a transaction is initiated on the network. Once the issuer (receiving Telco 685) approves the transaction, they send an acknowledgement to the customer Telco 693 who in turn sends a message to the customer 695 confirming the payment to Aneis Grocery, optionally with a confirmation number. Then, the receiving Telco 685 can also notify the merchant that a payment has been made. At this point, the customer can be allowed out of the store with the groceries or the like that he or she has purchased.

For the avoidance of doubt, in some embodiments, Telco 693 communicates with BPPS 687 via API 691 and instructs the BPPS to initiate the special payment transaction with interface 997. In other cases, Telco 693 has access to a payment card network via a PNIP or the like and initiates the special payment transaction itself.

Again, note that in one or more embodiments, the electronic bill payment system 687 originates a payment transaction to a payment card network 2008 to deposit the funds to the merchant's card (in at least some embodiments, in real time). The payment card network may have the same brand and be operated by the same entity as the electronic bill payment system (e.g., MASTERCARD RPPS ELECTRONIC BILL PAYMENT SYSTEM AND MASTERCARD BANKNET PAYMENT CARD NETWORK), or the two may be branded and operated separately.

One or more embodiments provide the capability to settle a mobile bill payment with the business 683 using a special transaction (e.g., ISO-8583 message type 0100 with transaction type twenty eight, or an ISO-8583 message type 0200 with transaction type twenty eight, as discussed elsewhere herein), such as the MasterCard MONEYSEND Payment Transaction or through similar payment transactions on partner networks.

The special transaction as discussed above is a payment card transaction that allows funds to be pushed to a cardholder's payment card account.

Several different non-limiting exemplary scenarios regarding special transactions such as the MasterCard payment transaction or MoneySend will now be presented. In one scenario, a dual message model is employed. An “auth request” is sent (ISO-8583 message 0100 with Transaction Type (DE3sfl)=“28” (Payment Transaction)) from the consumer's bank to the merchant's bank, over a payment card network (network 2008 is a non-limiting example). This guarantees the money transfer (reserves funds for the merchant). Subsequently (for example, in one day) a “First Presentment” message 1240 is sent in a bulk file which completes the transfer. In another scenario, a single message model is utilized. A Financial Transaction request is sent (ISO-8583 message 0200 with Transaction Type (DE3sfl)=“28” (Payment Transaction)) from the consumer's bank to the merchant's bank, over a payment card network (network 2008 is a non-limiting example). It will be appreciated that in at least some embodiments, Telco 685 and/or its sponsor bank 689 may take on the role of the merchant's bank, while Telco 693 and/or its sponsor bank 688 may take on the role of the consumer's bank

It is worth noting at this point that ISO 8583 message type 0100 is used in a conventional transaction as an authorization request from the acquirer 2006 to the issuer 2010 of the consumer's card, to which the issuer 2010 responds with an authorization request response 0110. The message type 0100 is also utilized conventionally for chargebacks and the like. The message type 0100 is utilized in a different way here based on a different code/transaction type than in the conventional applications (Transaction Type (DE3sfl)=“28” (Payment Transaction)).

Thus, while the special transaction such as the MasterCard MoneySend payment transaction with transaction type “28” is itself known, one or more embodiments advantageously provide mobile payments techniques which operate with this kind of special transaction.

In one or more embodiments, a suitable BPPS 687 with a biller directory 797 causes payment to the merchant's payment card account via “special” Transaction Type (DE3sfl)=“28” functionality as described above, or similar functionality.

Currently in the US, a biller directory within MasterCard RPPS is used to route bill payments electronically instead of the payment being cut to check.

An electronic payment bill payment system such as BPPS 687 conventionally allows people to specify payments to billers, typically settled by ACH type transfers from a deposit account. Pertinent formats, familiar to the skilled artisan, include NACHA ACH CCD, CCD+, CTX, RPPS proprietary format, and Visa ePay proprietary format.

Note that US Patent Application Publication 2010-0100480 A1 of Theresa Altman et al. (expressly incorporated herein by reference in its entirety for all purposes) discloses an innovative technique for allowing users of an electronic payment bill payment system to pay billers using payment card accounts of the payors not the billers, by sending a non-financial message through the electronic payment bill payment system, including the card number of the payor's card; the biller then charges the payor's card in a conventional manner. In contrast, one or more embodiments make a payment to the payment card account of the biller by having an entity such as BPPS-CPC 504 initiate a special payment transaction as described herein into a payment card network 2008 to make a payment to the payment card account of the biller 683.

In some cases, the assigned unique Biller identifiers (Biller IDs) are stored in directory 797 together with other pertinent data, for example, and are optionally published to the appropriate party(ies).

Thus, one or more embodiments advantageously provide an easy way for buyers to pay sellers in underdeveloped countries with only mobile phones. One or more embodiments are easy and profitable for mobile telephony providers and banks to adopt. One or more embodiments provide a ubiquitous system in which a seller can receive a payment from any buyer whose Telco accepts MasterCard (or other payment card) payments. In some cases, Telcos need not be connected to MIPs or other PNIPs and employ only simple API integration. In the current four party model, the acquirer has a direct relationship with the merchant and provides capabilities for proximity and remote payments. This model assumes that the consumer is interacting with a terminal or website controlled by the merchant and backed by the acquirer. In one or more embodiments, to support mobile payments, no physical cards or terminals are needed. The consumer can use any participating Telco to make a payment, providing an open loop system.

When the consumer makes a purchase, the consumer's Telco debits the consumer's account. The Acquiring Telco can use any account: MasterCard, Visa, SVA (stored value account), demand deposit account (DDA), and the like. In one or more embodiments, once the consumer's funds are secured, the consumer's Telco initiates a MoneySend Payment Transaction to the MasterCard Network using the Merchant's ID. The Merchant's Telco receives the payment transaction and posts the funds to the merchant's account. The Merchant receives real-time notification payment is complete.

It should be noted that customers are referred to essentially interchangeably herein as consumers or buyers.

A simple process is provided or a merchant to register to accept payments with a registered Telco. Registration can be done by SMS, app, online, or in person. The merchant is given an ID that the merchant uses to get paid. The Merchant ID allows the merchant not to disclose its phone number as well as allowing for payments to be made to a central account for multiple sellers of the same business. In some cases, the Telco backs the mobile money account with a MasterCard (or other) prepaid card, and the Telco collects the merchant information and uses a simple API 691 to register the merchant.

Furthermore in this regard, the consumer is asked to follow simple instructions to make an SMS payment. Instructions are posted at checkout. The consumer's Telco should be a MasterCard acceptor (or other brand that is sponsoring the implementation). The consumer's Telco makes two simple API calls to MasterCard, to confirm the merchant, and to initiate payment. This approach is advantageous if the sender is authenticated by the Telco, guaranteeing no chargebacks.

In one or more embodiments, the acquirer does not have a direct relationship with the merchant. The merchant signs up for payment acceptance with the merchant's Telco (which plays role of program manager/issuer). One or more embodiments do not allow chargebacks so fraud and risk do not need to be evaluated before sending payments. One or more embodiments advantageously assure that the sender is the owner of the phone. Rules to address chargebacks can be provided id desired or required.

In some embodiments, pricing is similar to ATM (automated teller machine) transactions. The Merchant's Telco pays a fee, the system operator (e.g., MasterCard) is entitled to a portion, and pays the Acquirer a fee.

One or more embodiments can be implemented by modifying an existing bill payment system such as a BPPS; use can be made of a Biller (e.g., merchant or business) Directory. Modifications include creating APIs for adding merchants in real-time, updating the biller directory to store merchant payment card accounts at which the merchants receive funds via special transactions, and integrating to a payment card network via PNIP and/or API to make a payment to a card account via special transaction as described herein.

### Recapitulation

Given the discussion thus far, it will be appreciated that, in general terms, an exemplary method, according to an aspect of the invention, includes the step of obtaining, at an electronic system for mobile open payments (e.g., electronic bill payment system 687 modified with the teachings herein), from a first mobile telephony provider entity (e.g., Telco 685 and/or its partner 689), first merchant registration information including at least a merchant name and address of a first merchant 683 who is a customer of the first mobile telephony provider entity and who is registering with the first mobile telephony provider entity to receive mobile payments. In at least some instances, this is carried out via system 687 exposing API 691 to the first mobile telephony provider entity. A further step includes assigning, from the electronic system for mobile open payments, to the first mobile telephony provider entity, a unique merchant identifier to identify the first merchant 683 (assignment can include, e.g., creating a new alphanumeric ID or using a phone number or other existing ID). Thus, as noted, this unique merchant identifier can be a Biller identifier/Merchant identifier or even the merchant's phone number. In at least some instances, this is also carried out via system 687 exposing API 691 to the first mobile telephony provider entity.

A still further step includes obtaining, at the electronic system for mobile open payments, from a second mobile telephony provider entity (e.g., Telco 693 and/or its partner 688 with optional involvement of wallet provider 694), a query. The query is initiated based on a payment instruction from a customer 695 of the first merchant and the second mobile telephony provider entity. The payment instruction instructs the first merchant to be paid a certain amount. The query includes the unique merchant identifier of the first merchant. In at least some instances, this is carried out via system 687 exposing API 691 to the second mobile telephony provider entity. Yet a further step includes looking up, in a database, by the electronic system for mobile open payments, via a query on the unique merchant identifier of the first merchant, at least a portion of the first merchant registration information. For example, DBMS 799, discussed below, queries biller directory 797.

An even further step includes providing, from the electronic system for mobile open payments, to the second mobile telephony provider entity, at least the portion of the first merchant registration information. In at least some instances, this is carried out via system 687 exposing API 691 to the second mobile telephony provider entity.

In one or more embodiments, a real-time payment is ultimately made to the merchant for the purchase of goods and/or services, and the merchant receives a notification of payment and releases the goods and/or services.

Note that one form of electronic system for mobile open payments is an electronic bill payment system 687 modified with the teachings herein as shown in FIG. 8; existing BPPS databases 1099 make this a desirable approach. However, in other embodiments, the electronic system for mobile open payments has components and connectivity similar to that in FIGS. 6 and 8 but is not implemented as part of a BPPS but rather in a stand-alone manner; e.g., a stand-alone system such as 900 or the like.

In some instances, a further step includes the electronic bill payment system 687 dispatching into a payment card network (e.g., 2008) a request for a special payment transaction wherein funds will be deposited to a payment card account of the first merchant. This can be carried out with a suitable payment card network interface 997, discussed below, such as a MIP or other PNIP. The request can be, for example, an authorization request or the like, such as an ISO-8583 message type 0100 with transaction type twenty eight or an ISO-8583 message type 0200 with transaction type twenty eight.

Alternatively, in some cases, a further step includes obtaining, in a payment card network 2008 (which can be operated, for example, by the operator who also operates the electronic bill payment system 687), a request for a special payment transaction wherein funds will be deposited to a payment card account of the first merchant. For example, a message is routed to Telco 685, which initiates the request via API 691 or MIP 694 or other PNIP. Again, the request can be, for example, an authorization request or the like, such as an ISO-8583 message type 0100 with transaction type twenty eight or an ISO-8583 message type 0200 with transaction type twenty eight.

Furthermore, given the discussion thus far, it will be appreciated that, in general terms, another exemplary method, according to another aspect of the invention, includes the step of obtaining, by a first mobile telephony provider entity (defined above), first merchant registration information including at least a merchant name and address of a first merchant 683 who is a customer of the first mobile telephony provider entity and who is registering with the first mobile telephony provider entity to receive mobile payments. This step can be carried out, for example, via a first cellular network operated by Telco 685. A further step includes providing, by the first mobile telephony provider entity, to an electronic system for mobile open payments (e.g., electronic bill payment system 687), the first merchant registration information. This step can be carried out, for example, by the first mobile telephony provider entity accessing an application programming interface 691 exposed by the electronic bill payment system 687. A still further step includes obtaining, from the electronic system for mobile open payments, by the first mobile telephony provider entity, an assignment of a unique merchant identifier (discussed above) to identify the first merchant 683. This step can be carried out, for example, by the first mobile telephony provider entity accessing the application programming interface exposed by the electronic bill payment system. An even further step includes providing, by the first mobile telephony provider entity, to the first merchant, the unique merchant identifier, for display by the first merchant to solicit the mobile payments. This step could be carried out, for example, via the first cellular network, e-mail, “snail” mail (e.g., of a counter display or the like), and so on.

In some cases, a further step includes sending, by the first mobile telephony provider entity, to the first merchant 683, a confirmation of payment identifying a payment amount and a mobile telephone number of a customer 695 of the first merchant who has paid the first merchant via the customer's mobile telephone, in response to the display of the unique merchant identifier, by the first merchant. This step could be carried out, for example, via the first cellular network.

In some instances, a further step includes the first mobile telephony provider entity deducting a fee from an account of the first merchant to charge the first merchant for receiving the payment amount from the customer of the first merchant, as referred to in the confirmation. This step can be carried out, for example, via a server (e.g., 900) of the first mobile telephony provider or partner using a database management system to access database 696 to update the balance. In some such instances, an even further step includes the first mobile telephony provider entity sharing a portion of the fee deducted from the account of the first merchant with an operator of the electronic bill payment system. This can be carried out using any suitable electronic or paper-based payment mechanism.

Even further, given the discussion thus far, it will be appreciated that, in general terms, still another exemplary method, according to still another aspect of the invention, includes the step of obtaining, at a customer's mobile telephony provider entity (e.g., Telco 693 and/or its partner 688 with optional involvement of wallet provider 694), from a customer 695 who is a customer of the mobile telephony provider entity and the merchant 683, a first mobile telephony message (a text message is a non-limiting example) including a unique merchant identifier and an amount due. The message is in connection with a transaction between the customer and the merchant wherein the unique merchant identifier is displayed to the customer. This step can be carried out, for example, via a second cellular network operated by Telco 693. A further step includes charging, by the customer's mobile telephony provider entity, to an account of the customer, funds to pay the amount due. This step can be carried out, for example, by a database management system module, embodied in a tangible non-transitory computer readable storage medium, executing on at least one hardware processor, updating a database (e.g., on server such as 900 of customer's mobile telephony provider entity). An even further step includes causing, by the customer's mobile telephony provider entity, a request for a special payment transaction wherein funds will be deposited to a payment card account of the merchant, to be dispatched into a payment card network. In one aspect, the customer's mobile telephony provider entity causes the request for the special payment transaction to be dispatched into the payment card network by instructing an electronic bill payment system 687 to dispatch the request for the special payment transaction. For example, API 691 is accessed and BPPS 687 access the payment card network 2008 via a MIP or other PNIP. In an alternative aspect, the customer's mobile telephony provider entity causes the request for the special payment transaction to be dispatched into the payment card network by notifying the merchant's Telco 685, via suitable wired or wireless connectivity; the merchant's Telco 685 then initiates the special payment transaction via an API or MIP or other PNIP.

Note that an API from an entity into a payment card network for initiating a special payment transaction may be logically different than other API(s) 691 where the operator of the BPPS 687 and payment card network 2008 are not the same.

In some cases, a further step includes providing, to an electronic bill payment system 687, from the customer's mobile telephony provider entity, a query. The query is initiated based on the first mobile telephony message. The query includes the unique merchant identifier of the first merchant. This step can be carried out, for example, by the customer's mobile telephony provider entity accessing API 691. A still further step includes obtaining, from the electronic bill payment system 687, by the second mobile telephony provider entity, responsive to the query, at least the name of the first merchant 683. This step can also be carried out, for example, by the customer's mobile telephony provider entity accessing API 691. A still further step includes providing, to the customer, a second mobile telephony message asking the customer to confirm that it is desired to pay the amount due to the first merchant, wherein the first merchant is identified in the second mobile telephony message by the name of the first merchant. This step can be carried out, for example, by the cellular network operated by Telco 693. An even further step includes obtaining, at the customer's mobile telephony provider entity, from the customer, a third mobile telephony message confirming the desire to pay. This step can also be carried out, for example, by the cellular network operated by Telco 693. The step of causing the request for the special payment transaction to be dispatched is responsive to the confirmation; for example, based on logic on a server such as server 900 of Telco 693.

In still another aspect, an exemplary apparatus includes a memory (e.g., RAM, ROM, on-processor chip memory of 930); at least one processor 920 operatively coupled to the memory; and a persistent storage device (e.g., hard disk, flash memory portion of 930) operatively coupled to the memory and storing in a non-transitory manner instructions which, when loaded into the memory, cause the at least one processor to be configured to carry out any one, some, or all of the method steps described herein. System 900 is generally representative of a server of BPPS 687, 1006; a server of the merchant Telco 685 or its partner(s), or a server of the buyer Telco 693 or its partners.

### System and Article of Manufacture Details

Embodiments of the invention can employ hardware and/or hardware and software aspects. Software includes but is not limited to firmware, resident software, microcode, etc. FIG. 8 presents an exemplary software architecture diagram. BPPS 687 includes conventional bill presentment and payment functionality, as well as BPPS-CPC 504. Also included are a database management system (DBMS) 799 to access biller directory 797 (note that databases 696, 698 may also be accessed by suitable database management systems, which are omitted from FIG. 6 to avoid clutter); novel API(s) 691 (one or more APIs) to provide an interface with Telcos and/or their sponsoring banks; a graphical user interface (GUI) 999 to provide an interface with users (other kinds of interfaces can also be employed); and a payment card network interface 997 to interface with a payment card network such as 2008 or other payment card network. Interface 997 could be a PNIP such as a front end communications processor such as a MASTERCARD INTERFACE PROCESSOR™ or MIP™ processor (trademarks of MasterCard International, Inc. of Purchase, N.Y.). The user interface can be implemented, for example, via a user interface module. The module can include a graphical user interface (GUI), such as that formed by a server (e.g., system 900 discussed below) serving out hypertext markup language (HTML) code to a browser of a user (system 900 is also representative of a computing device of a user as is mobile device 400).

Regarding BPPS-CPC 504, in some embodiments, the special payment transaction is recognized as one requiring electronic payment via BPPS-CPC 504 (e.g., based on transaction type “28”), and thus the instructions are routed to BPPS-CPC 504, which accesses the biller directory 797. Such access can be, for example, by using database management system (DBMS) 799 to query biller directory 797 for the record(s) associated with the Biller ID included in the payment instructions. The BPPS-CPC 504 retrieves the corresponding payment card account to which payment is to be made, and submits a special payment card transaction of the kind described above to that payment card account, via a payment card network such as network 2008 (e.g., MasterCard BANKNET, VISANET, or other networks discussed herein). The issuer (here, Telco 685) of the payment card account of the small business 683 then deposits funds in that account; in at least some cases, in real time.

Software might be employed, for example, in connection with one or more of BPPS 687/1006 and its components; a terminal 122, 124, 125, 126; a reader 132; a host, server, and/or processing center 140, 142, 144 (optionally with data warehouse 154) of a merchant, issuer, acquirer, processor, Telco, bank, agent, other third party described herein, or operator of a network 2008; a mobile device 400; and the like. Firmware might be employed, for example, in connection with payment devices such as cards 102, 112, as well as reader 132.

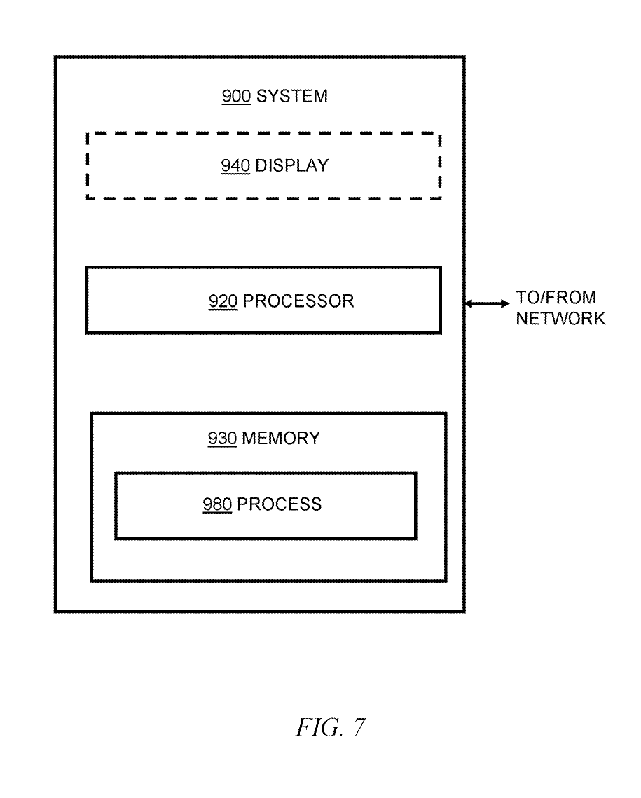

FIG. 7 is a block diagram of a system 900 that can implement part or all of one or more aspects or processes of the invention. As shown in FIG. 7, memory 930 configures the processor 920 (which could correspond, e.g., to processor portions 106, 116, 130; a processor of a terminal or a reader 132; processors of remote hosts in centers 140, 142, 144; processors of hosts and/or servers implementing BPPS 687 and its components; processors of hosts and/or servers of other parties described herein; and the like); to implement one or more aspects of the methods, steps, and functions disclosed herein (collectively, shown as process 980 in FIG. 7). Different method steps can be performed by different processors. The memory 930 could be distributed or local and the processor 920 could be distributed or singular. The memory 930 could be implemented as an electrical, magnetic or optical memory, or any combination of these or other types of storage devices (including memory portions as described above with respect to cards 102, 112). It should be noted that if distributed processors are employed, each distributed processor that makes up processor 920 generally contains its own addressable memory space. It should also be noted that some or all of computer system 900 can be incorporated into an application-specific integrated circuit (ASIC) or general-use integrated circuit. For example, one or more method steps could be implemented in hardware in an ASIC or field-programmable gate array (FPGA) rather than using firmware. Display 940 is representative of a variety of possible input/output devices (e.g., displays, printers, keyboards, mice, touch screens, touch pads, and so on). Furthermore, system 900 is also generally representative of a mobile device such as a tablet or “smart” phone 400, in which case input/output will typically be via a touch screen (possibly with a small keyboard) and communications to and from a network will be via cellular telephone or Wi-Fi connection, as discussed above.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010; on a computer implementing BPPS 687/1006 and its components; on processors of hosts and/or servers of other parties described herein; on device 400; and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, 122, 124, 125, 126, 140, 142, 144, 2004, 2006, 2008, 2010; a computer implementing BPPS 687/1006 and its components; on processors of hosts and/or servers of other parties described herein; on device 400; and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 900 as shown in FIG. 7) running a server program. It will be understood that such a physical server may or may not include a display, keyboard, or other input/output components. A “host” includes a physical data processing system (for example, system 900 as shown in FIG. 7) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. Referring again to FIG. 8, in one or more embodiments, the modules include a database module 799 accessing a biller directory 797 stored in persistent storage, a BPPS-CPC module to implement BPPS-CPC 504, a GUI module to implement GUI 999; a module or modules with code to implement one or more APIs, and/or one or more modules implementing conventional BPPS functionality (omitted from FIG. 10 to avoid clutter). The database module can include, for example, a (relational, graphical, or other) database management system (DBMS) 799 which provides access to database 797 via queries and the like. A MIP is a front-end communications processor that is, for example, placed on-site at a MasterCard customer's facility by MasterCard for the purpose of providing access to the BANKNET telecommunication network. When interface 997 is implemented as a MIP or other PNIP, for example, it may be on a separate hardware processor from BPPS 687/1006 and may communicate therewith via a suitable network. Appropriate software modules may run on the MIP or other PNIP. In other embodiments, software modules and/or a network interface card or the like are provided on the same machine as BPPS 1006 to interface with the payment card network. Software modules can also be provided on mobile device 400 to implement the browser and apps. The method steps can, in any event, be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

One example of a user interface module to implement a UI is hypertext markup language (HTML) code served out by a server operated by payment network 2008 or the like, to a browser of a computing device of a user. The HTML is parsed by the browser on the user's computing device to create a graphical user interface (GUI).

Thus, aspects of the invention can be implemented, for example, by one or more appropriately programmed general purpose computers, such as, for example, servers, mobile devices, or personal computers, located at one or more of the entities in the figures, as well as within the payment network 2008 and/or payment system 687/1006. Such computers can be interconnected, for example, by one or more of payment network 2008, another VPN, the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, Structured Query Language (SQL), and the like (an exemplary and non-limiting list), and can also make use of, for example, Extensible Markup Language (XML), known application programs such as relational database applications (e.g., IBM DB2® software available from International Business Machines Corporation, Armonk, N.Y., US; SAS® software available from SAS Institute, Inc., Cary, N.C., US), spreadsheets (e.g., MICROSOFT EXCEL® software available from Microsoft Corporation, Redmond, Wash., US), and the like. The computers can be programmed to implement the logic and/or data flow depicted in the figures. In some instances, messaging and the like may be in accordance with the International Organization for Standardization (ISO) Specification 5583 Financial transaction card originated messages—Interchange message specifications and/or the ISO 20022 or UNIFI Standard for Financial Services Messaging, also incorporated herein by reference in its entirety for all purposes. In one or more embodiments, some messages may be in accordance with NACHA Automated Clearing House (ACH) rules and regulations.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
obtaining, at an electronic system for mobile open payments, from a first mobile telephony provider entity, first merchant registration information comprising at least a merchant name and address of a first merchant who is a customer of said first mobile telephony provider entity and who is registering with said first mobile telephony provider entity to receive mobile payments;
assigning, from said electronic system for mobile open payments, to said first mobile telephony provider entity, a unique merchant identifier to identify said first merchant;
obtaining, at said electronic system for mobile open payments, from a second mobile telephony provider entity, a query, initiated based on a payment instruction from a customer of said first merchant and said second mobile telephony provider entity instructing said first merchant to be paid a certain amount, said query including said unique merchant identifier of said first merchant;
looking up, in a database, by said electronic system for mobile open payments, via a query on said unique merchant identifier of said first merchant, at least a portion of said first merchant registration information; and
providing, from said electronic system for mobile open payments, to said second mobile telephony provider entity, at least said portion of said first merchant registration information.

2. The method of claim 1, wherein said electronic system for mobile open payments comprises an electronic bill payment system, further comprising said electronic bill payment system dispatching into a payment card network a request for a special payment transaction wherein funds will be deposited to a payment card account of said first merchant.

3. The method of claim 2, wherein said dispatching comprises dispatching one of an ISO-8583 message type 0100 with transaction type twenty eight and an ISO-8583 message type 0200 with transaction type twenty eight.

4. The method of claim 1, wherein said electronic system for mobile open payments comprises an electronic bill payment system, further comprising obtaining, in a payment card network operated by an operator who also operates said electronic bill payment system, a request for a special payment transaction wherein funds will be deposited to a payment card account of said first merchant.

5. The method of claim 4, wherein said obtaining of said request for said special payment transaction comprises obtaining one of an ISO-8583 message type 0100 with transaction type twenty eight and an ISO-8583 message type 0200 with transaction type twenty eight.

6. The method of claim 1, wherein:
said electronic system for mobile open payments comprises an electronic bill payment system;
said obtaining of said first merchant registration information is carried out by said electronic bill payment system exposing an application programming interface to said first mobile telephony provider entity;
said providing of said unique merchant identifier is carried out by said electronic bill payment system exposing said application programming interface to said first mobile telephony provider entity;
said obtaining of said query is carried out by said electronic bill payment system exposing said application programming interface to said second mobile telephony provider entity;
said looking up of said at least a portion of said first merchant registration information is carried out by a database management system module, embodied in a tangible non-transitory computer readable storage medium, executing on at least one hardware processor, querying a biller directory database; and
said providing, from said electronic bill payment system, to said second mobile telephony provider entity, of said at least portion of said first merchant registration information, is carried out by said electronic bill payment system exposing said application programming interface to said second mobile telephony provider entity.

7. A method comprising the steps of:
obtaining, by a first mobile telephony provider entity, first merchant registration information comprising at least a merchant name and address of a first merchant who is a customer of said first mobile telephony provider entity and who is registering with said first mobile telephony provider entity to receive mobile payments;
providing, by said first mobile telephony provider entity, to an electronic system for mobile open payments, said first merchant registration information;
obtaining, from said electronic system for mobile open payments, by said first mobile telephony provider entity, an assignment of a unique merchant identifier to identify said first merchant; and
providing, by said first mobile telephony provider entity, to said first merchant, said unique merchant identifier, for display by said first merchant to solicit said mobile payments.

8. The method of claim 7, further comprising:
sending, by said first mobile telephony provider entity, to said first merchant, a confirmation of payment identifying a payment amount and a mobile telephone number of a customer of said first merchant who has paid said first merchant via said customer's mobile telephone, in response to said display of said unique merchant identifier, by said first merchant.

9. The method of claim 8, further comprising said first mobile telephony provider entity deducting a fee from an account of said first merchant to charge said first merchant for receiving said payment amount from said customer of said first merchant, as referred to in said confirmation.

10. The method of claim 9, wherein said electronic system for mobile open payments comprises an electronic bill payment system, further comprising said first mobile telephony provider entity sharing a portion of said fee deducted from said account of said first merchant with an operator of said electronic bill payment system.

11. The method of claim 7, wherein:
said electronic system for mobile open payments comprises an electronic bill payment system;
said obtaining, by said first mobile telephony provider entity, of said first merchant registration information, is carried out via a first cellular network;
said providing, by said first mobile telephony provider entity, to said electronic bill payment system, of said first merchant registration information, is carried out by said first mobile telephony provider entity accessing an application programming interface exposed by said electronic bill payment system; and
said obtaining, from said electronic bill payment system, by said first mobile telephony provider entity, of said unique merchant identifier, is carried out by said first mobile telephony provider entity accessing said application programming interface exposed by said electronic bill payment system.

12. A method comprising the steps of:
obtaining, at a customer's mobile telephony provider entity, from a customer who is a customer of said mobile telephony provider entity and a merchant, a first mobile telephony message including a unique merchant identifier and an amount due, in connection with a transaction between said customer and said merchant wherein said unique merchant identifier is displayed to said customer;
charging, by said customer's mobile telephony provider entity, to an account of said customer, funds to pay said amount due; and
causing, by said customer's mobile telephony provider entity, a request for a special payment transaction wherein funds will be deposited to a payment card account of said merchant, to be dispatched into a payment card network.

13. The method of claim 12, wherein said customer's mobile telephony provider entity causes said request for said special payment transaction to be dispatched into said payment card network by instructing an electronic bill payment system to dispatch said request for said special payment transaction.

14. The method of claim 12, wherein said customer's mobile telephony provider entity causes said request for said special payment transaction to be dispatched into said payment card network by itself dispatching a message to a mobile telephony provider entity of said merchant.

15. The method of claim 12, further comprising:
providing, to an electronic bill payment system, from said customer's mobile telephony provider entity, a query, initiated based on said mobile telephony message, said query including said unique merchant identifier of said first merchant;
obtaining, from said electronic bill payment system, by said second mobile telephony provider entity, responsive to said query, at least a name of said first merchant;
providing, to said customer, a second mobile telephony message asking said customer to confirm that it is desired to pay said amount due to said first merchant, wherein said first merchant is identified in said second mobile telephony message by said name of said first merchant; and
obtaining, at said customer's mobile telephony provider entity, from said customer, a third mobile telephony message confirming said desire to pay;
wherein said step of causing said request for said special payment transaction to be dispatched is responsive to said confirmation.

16. The method of claim 12, wherein:
said obtaining, at said customer's mobile telephony provider entity, of said first mobile telephony message is carried out via a first cellular network; and
said deducting, by said customer's mobile telephony provider entity, of said funds, is carried out by a database management system module, embodied in a tangible non-transitory computer readable storage medium, executing on at least one hardware processor, updating a database.

17. An apparatus, comprising:
a memory;
at least one processor operatively coupled to said memory; and
a persistent storage device operatively coupled to said memory and storing in a non-transitory manner instructions which, when loaded into said memory, cause said at least one processor to be configured:
to obtain, from a first mobile telephony provider entity, first merchant registration information comprising at least a merchant name and address of a first merchant who is a customer of said first mobile telephony provider entity and who is registering with said first mobile telephony provider entity to receive mobile payments;
to assign, to said first mobile telephony provider entity, a unique merchant identifier to identify said first merchant;
to obtain, from a second mobile telephony provider entity, a query, initiated based on a payment instruction from a customer of said first merchant and said second mobile telephony provider entity instructing said first merchant to be paid a certain amount, said query including said unique merchant identifier of said first merchant;
to look up, in a database, via a query on said unique merchant identifier of said first merchant, at least a portion of said first merchant registration information; and
to provide, to said second mobile telephony provider entity, at least said portion of said first merchant registration information.

18. The apparatus of claim 17, wherein said persistent storage device further stores in a non-transitory manner instructions which, when loaded into said memory, cause said at least one processor to be configured to dispatch into a payment card network a request for a special payment transaction wherein funds will be deposited to a payment card account of said first merchant.

19. The apparatus of claim 18, wherein said request comprises one of an ISO-8583 message type 0100 with transaction type twenty eight and an ISO-8583 message type 0200 with transaction type twenty eight.

20. The apparatus of claim 17, wherein:
said instructions on said persistent storage device comprise a database management system module and a module implementing said application programming interface;
said at least one processor is operative to obtain said first merchant registration information by executing said module implementing said application programming interface;
said at least one processor is operative to provide said unique merchant identifier by executing said module implementing said application programming interface;
said at least one processor is operative to obtain said query by executing said module implementing said application programming interface;
said at least one processor is operative to look up said at least a portion of said first merchant registration information by executing said database management system module; and
said at least one processor is operative to provide said at least portion of said first merchant registration information by executing said module implementing said application programming interface.
